(19) United States
(12) Patent Application Publication
(10) Pub. No.: US 2017/0182781 A1
(43) Pub. Date: Jun. 29, 2017

(54) LIQUID SUPPLYING UNIT AND LIQUID EJECTING SYSTEM

(71) Applicant: SEIKO EPSON CORPORATION, Tokyo (JP)

(72) Inventors: Yoshiaki SHIMIZU, Matsumoto (JP); Satoshi SHINADA, Shiojiri (JP); Taku ISHIZAWA, Matsumoto (JP); Noriyuki FUKASAWA, Shiojiri (JP)

(21) Appl. No.: 15/381,473

(22) Filed: Dec. 16, 2016

(30) Foreign Application Priority Data
Dec. 28, 2015 (JP) 2015-256065

(51) Int. Cl. B41J 2/175

(52) U.S. Cl. CPC B41J 2/1752; B41J 2/17553

(57) ABSTRACT

A further improvement in convenience is desired in conventional liquid ejecting systems. A liquid supplying unit is mountable to a carriage that has a first projection, a second projection and a liquid introduction needle. The unit includes six wall portions. The first wall portion is provided with a liquid supplying portion connectable to a liquid introduction needle, a first recess portion adapted to receive the first projection, and a second recess portion adapted to receive the second projection. In a planar view of the first wall portion, the liquid supplying portion is positioned closer to the fifth wall portion than to the sixth wall portion, and when the first wall portion is equally divided into a first region, a second region and a third region, the first recess portion is positioned in the first region, and the second recess portion is positioned in the third region.

### CROSS REFERENCE TO RELATED APPLICATIONS

This application claims priority to Japanese Application No. 2015-256065 filed on Dec. 28, 2015. The entire disclosure of this Japanese application is expressly incorporated by reference herein.

### BACKGROUND

1. Technical Field

The present invention relates to a liquid supplying unit, a liquid ejecting system and the like.

2. Related Art

Conventionally, as an example of a liquid ejecting apparatus, inkjet printers are known. In inkjet printers, ink, which is an example of a liquid, is discharged from an ejecting head onto a printing medium such as printing paper, thereby enabling printing onto the printing medium to be performed. In such inkjet printers, conventionally, a structure for supplying ink from an ink cartridge, which is an example of a liquid supplying unit, to the ejecting head is known (e.g., JP-A-2013-248779). Note that a structure in which the liquid supplying unit is mounted to the liquid ejecting apparatus will be referred to as a liquid ejecting system.

JP-A-2013-248779 is an example of related art.

### SUMMARY

In the inkjet printer described in JP-A-2013-248779 above, the ink cartridge is mounted to a holder. This ink cartridge is provided with a lever that is engageable with the holder. In the state where the lever is engaged with the holder, the ink cartridge is mounted to the holder. In order to mount the ink cartridge to the holder, the user inserts the ink cartridge that he or she holds into the holder, and engages the lever with the holder. Thereby, the ink cartridge is mounted to the holder. At this time, the ink cartridge is manually mounted by the user. This is considered to be one of the factors that cause the entering orientation of the ink cartridge relative to the holder when the ink cartridge is inserted into the holder to vary easily. When the entering orientation of the ink cartridge comes out of an appropriate range, it is conceivable that the lever will not be properly engaged with the holder, and that the ink cartridge will be caught by the holder before the lever is engaged with the holder. If such a situation occurs, the convenience when mounting the ink cartridge to the holder deteriorates. Accordingly, in conventional liquid ejecting systems, further improvement in convenience is desired.

The invention can solve at least the above-described issue, and can be realized as the following aspects or application examples.

### Application Example 1

A liquid supplying unit that is mountable to a carriage having a first projection, a second projection and a liquid introduction needle positioned between the first projection and the second projection includes: a first wall portion; a second wall portion opposing the first wall portion; a third wall portion intersecting the first wall portion and the second wall portion; a fourth wall portion intersecting the first wall portion and the second wall portion, and opposing the third wall portion; a fifth wall portion intersecting the first wall portion, the second wall portion, the third wall portion and the fourth wall portion; and a sixth wall portion intersecting the first wall portion, the second wall portion, the third wall portion and the fourth wall portion, and opposing the fifth wall portion, wherein the first wall portion is provided with a liquid supplying portion connectable to the liquid introduction needle, a first recess portion adapted to receive the first projection, and a second recess portion adapted to receive the second projection, and in a planar view of the first wall portion in a direction from the first wall portion toward the second wall portion: the liquid supplying portion is positioned closer to the fifth wall portion than to the sixth wall portion; and when the first wall portion is equally divided into a first region, a second region and a third region in a direction from the fifth wall portion toward the sixth wall portion, the first recess portion is positioned in the first region, and the second recess portion is positioned in the third region.

In this liquid supplying unit, the first projection can be inserted into the first recess portion, and the second projection can be inserted into the second recess portion. Therefore, when mounting the liquid supplying unit to the carriage, the first recess portion and the second recess portion can be used as guides for the mounting. It is possible to reduce variation in the orientation of the liquid supplying unit relative to the carriage when mounting the liquid supplying unit to the carriage. As a result, it is easy to improve the convenience when mounting the liquid supplying unit to the carriage.

### Application Example 2

In the above-described liquid supplying unit, the first wall portion may be provided with a detection target unit in which a liquid residual quantity is detected, and in a planar view of the first wall portion in the direction from the first wall portion toward the second wall portion: the liquid supplying portion may be positioned closer to the fifth wall portion than to the sixth wall portion; the first recess portion may be positioned closer to the fifth wall portion than the liquid supplying portion; the second recess portion may be positioned closer to the sixth wall portion than the liquid supplying portion; and the detection target unit may be positioned between the first recess portion and the second recess portion in a direction from the fifth wall portion toward the sixth wall portion.

According to such a configuration, the first projection can be inserted into the first recess portion, and the second projection can be inserted into the second recess portion. Therefore, when mounting the liquid supplying unit to the carriage, the position of the first recess portion can be regulated by the first projection, and the position of the second recess portion can be regulated by the second projection. As a result, it is possible to reduce variation in the orientation of the liquid supplying unit relative to the carriage after the liquid supplying unit is mounted to the carriage. As a result, it is easy to suppress deterioration in the detection accuracy in the detection target unit.

### Application Example 3

The above-described liquid supplying unit may further include a contact portion that is arranged on the fifth wall portion, and that comes into contact with an electrode of the carriage in a state where the liquid supplying unit is mounted to the carriage, wherein in a planar view of the first wall portion in the direction from the first wall portion toward the second wall portion, a portion of the liquid supplying portion capable of abutting on the liquid introduction needle, the contact portion, the first recess portion and the second recess portion may be arranged along a straight line.

According to such a configuration, the portion of the liquid supplying portion capable of abutting on the liquid introduction needle, the contact portion, the first recess portion and the second recess portion are each one of the factors that regulate the position of the liquid supplying unit relative to the carriage when the liquid supplying unit is mounted to the carriage. By aligning the factors that regulate the position of the liquid supplying unit relative to the carriage along a straight line, it is possible to improve a function of guiding the liquid supplying unit to the carriage when mounting the liquid supplying unit to the carriage.

### Application Example 4

In the above-described liquid supplying unit, the fifth wall portion may be provided with an engagement structure configured to engage with the carriage in a state where the liquid supplying unit is mounted to the carriage, so as to regulate displacement of the liquid supplying unit relative to the carriage in a first direction from the first wall portion toward the second wall portion, and in a planar view of the first wall portion in the direction from the first wall portion toward the second wall portion: a portion of the engagement structure capable of abutting on the carriage, the portion of the liquid supplying portion capable of abutting on the liquid introduction needle, the first recess portion and the second recess portion may be arranged along a straight line.

According to such a configuration, the portion of the engagement structure capable of abutting on the carriage, the portion of the liquid supplying portion capable of abutting on the liquid introduction needle, the first recess portion and the second recess portion are each one of the factors that regulate the position of the liquid supplying unit relative to the carriage when the liquid supplying unit is mounted to the carriage. By aligning the factors that regulate the position of the liquid supplying unit relative to the carriage along a straight line, it is possible to improve a function of guiding the liquid supplying unit relative to the carriage when mounting the liquid supplying unit to the carriage.

### Application Example 5

In the above-described liquid supplying unit, the first recess portion may be open in a direction from the second wall portion toward the first wall portion and in a direction from the third wall portion toward the fourth wall portion.

According to such a configuration, the first recess portion is open in two directions, and thus it is possible to easily insert the first projection into the first recess portion. Accordingly, the liquid supplying unit can be easily mounted to the carriage.

### Application Example 6

In the above-described liquid supplying unit, the second recess portion may be open in a direction from the second wall portion toward the first wall portion and in a direction from the third wall portion toward the fourth wall portion.

According to such a configuration, the second recess portion is open in two directions, and thus it is possible to easily insert the second projection into the second recess portion. Accordingly, the liquid supplying unit can be easily mounted to the carriage.

### Application Example 7

In a liquid ejecting system including an carriage and a liquid supplying unit that is mounted to the carriage and that is capable of containing a liquid, the carriage includes: a first projection; a second projection; and a liquid introduction needle positioned between the first projection and the second projection, the liquid supplying unit includes: a first wall portion; a second wall portion opposing the first wall portion; a third wall portion intersecting the first wall portion and the second wall portion; a fourth wall portion intersecting the first wall portion and the second wall portion, and opposing the third wall portion; a fifth wall portion intersecting the first wall portion, the second wall portion, the third wall portion and the fourth wall portion; and a sixth wall portion intersecting the first wall portion, the second wall portion, the third wall portion and the fourth wall portion, and opposing the fifth wall portion, the first wall portion is provided with a liquid supplying portion connectable to the liquid introduction needle, a first recess portion adapted to receive the first projection, and a second recess portion adapted to receive the second projection, in a planar view of the first wall portion in a first direction from the first wall portion toward the second wall portion: the liquid supplying portion is positioned between the fifth wall portion and the sixth wall portion; the first recess portion is positioned between the fifth wall portion and the liquid supplying portion; and the second recess portion is positioned between the sixth wall portion and the liquid supplying portion, assuming a direction from the second wall portion toward the first wall portion to be a second direction, the liquid supplying portion protrudes from the first wall portion in the second direction, the liquid supplying portion protrudes farther than a portion of the first wall portion in which the first recess portion is provided, by a first distance in the second direction, the first projection protrudes farther than the liquid introduction needle by a second distance in the first direction, and the second distance is greater than the first distance.

In this liquid ejecting system, when the liquid supplying unit is mounted to the carriage, the first projection is likely to enter the first recess portion before the liquid introduction needle enters the liquid supplying portion. Accordingly, when the liquid supplying unit is mounted to the carriage, the first recess portion is guided to the first projection, and thereby the liquid supplying portion is easily guided toward the liquid introduction needle. As a result, it is easy to stabilize the orientation of the liquid supplying unit relative to the carriage when the liquid introduction needle enters the liquid supplying portion.

### Application Example 8

In the above-described liquid ejecting system, the second projection may protrude farther than the liquid introduction needle by a third distance in the first direction, and the third distance may be greater than the first distance.

According to such a configuration, when the liquid supplying unit is mounted to the carriage, it is likely that the first projection enters the first recess portion, and the second projection enters the second recess portion before the liquid introduction needle enters the liquid supplying portion. Accordingly, when the liquid supplying unit is mounted to the carriage, the first recess portion is guided to the first projection, and the second recess portion is guided to the second projection, and thereby the liquid supplying portion is easily guided toward the liquid introduction needle. As a result, it becomes easier to further stabilize the orientation of the liquid supplying unit relative to the carriage when the liquid introduction needle enters the liquid supplying portion.

### Application Example 9

In the above-described liquid ejecting system, the liquid supplying unit may further include a contact portion that is arranged on the fifth wall portion, and that comes into contact with an electrode of the carriage, and the second distance may be greater than the third distance.

According to such a configuration, when the liquid supplying unit is mounted to the carriage, the first projection is likely to enter the first recess portion before the second projection enters the second recess portion. Therefore, when the liquid supplying unit is mounted to the carriage, the first recess portion is likely to be guided to the first projection before the second recess portion is guided to the second projection. Accordingly, the first recess portion is likely to be guided before the second recess portion. Also, the contact portion of the liquid supplying unit is provided on the fifth wall portion that is closer to the first recess portion than to second recess portion. In other words, the contact portion is closer to the first recess portion that is likely to be guided before the second recess portion. Therefore, when the liquid supplying unit is mounted to the carriage, the contact portion that is close to the first recess portion is likely to be guided at an early stage, and thus it is easy to stabilize the orientation of the liquid supplying unit relative to the carriage when the contact portion comes into contact with the electrode. As a result, when the liquid supplying unit is mounted to the carriage, the contact portion is easily brought into contact with the electrode in a stable manner.

### Application Example 10

In the above-described liquid ejecting system, the first recess portion and the contact portion may be provided at positions opposing each other such that the fifth wall portion is positioned therebetween.

According to such a configuration, the first recess portion and the contact portion are provided at positions opposing each other such that the fifth wall portion is positioned therebetween, and thus in a state where the liquid supplying unit is mounted to the carriage, a position relationship is obtained in which the contact portion is positioned between the electrode of the carriage and the first projection. Therefore, the contact portion is easily brought into contact with the electrode.

### Application Example 11

The above-described liquid ejecting system may include a detecting unit configured to detect a residual quantity of the liquid contained in the liquid supplying unit, wherein the liquid supplying unit may have, in the first wall portion, a detection target unit in which the residual quantity of the liquid is detected by the detecting unit, and in a planar view of the first wall portion in a direction from the first wall portion toward the second wall portion: the liquid supplying portion may be positioned closer to the fifth wall portion than to the sixth wall portion; the first recess portion may be positioned closer to the fifth wall portion than the liquid supplying portion; the second recess portion may be positioned closer to the sixth wall portion than the liquid supplying portion; and the detection target unit may be positioned between the first recess portion and the second recess portion in a direction from the fifth wall portion toward the sixth wall portion.

According to such a configuration, when mounting the liquid supplying unit to the carriage, the position of the first recess portion can be regulated by the first projection, and the position of the second recess portion can be regulated by the second projection. As a result, it is possible to reduce variation in the orientation of the liquid supplying unit relative to the carriage after the liquid supplying unit is mounted to the carriage. As a result, it is easy to suppress deterioration in detection accuracy when detecting the residual quantity of the liquid.

### BRIEF DESCRIPTION OF THE DRAWINGS

The invention will be described with reference to the accompanying drawings, wherein like numbers reference like elements.

FIG. 1 is a perspective view schematically showing a main configuration of a liquid ejecting system in a first embodiment.

FIG. 2 is a perspective view showing a holder in the first embodiment.

FIG. 3 is a perspective view showing the holder in the first embodiment.

FIG. 4 is a diagram showing the appearance of a cartridge in the first embodiment.

FIG. 5 is a diagram showing the appearance of the cartridge in the first embodiment.

FIG. 6 is a diagram showing the appearance of the cartridge in the first embodiment.

FIG. 7 is a diagram showing the appearance of the cartridge in the first embodiment.

FIG. 8 is a diagram showing the appearance of the cartridge in the first embodiment.

FIG. 9 is a diagram showing the appearance of the cartridge in the first embodiment.

FIG. 10 is a perspective view showing the appearance of the cartridge in the first embodiment.

FIG. 11 is a diagram showing the appearance of a circuit substrate in the first embodiment.

FIG. 12 is a cross-sectional view showing a liquid supplying portion in the first embodiment.

FIG. 13 is a cross-sectional view showing the liquid supplying portion in the first embodiment.

FIG. 14 is a perspective view showing the appearance of the cartridge in the first embodiment.

FIG. 15 is a cross-sectional view showing the cartridge in the first embodiment.

FIG. 16 is a cross-sectional view showing the cartridge and the holder in the first embodiment.

FIG. 17 is a diagram showing the appearance of the cartridge in the first embodiment.

FIG. 18 is a cross-sectional view showing the holder in the first embodiment.

FIG. 19 is a cross-sectional view showing the cartridge and the holder in the first embodiment.

FIG. 20 is a cross-sectional view showing the cartridge and the holder in the first embodiment.

FIG. 21 is a perspective view schematically showing a main configuration of a liquid ejecting system in a second embodiment.

FIG. 22 is a cross-sectional view showing a cartridge and a holder in the second embodiment.

FIG. 23 is a cross-sectional view schematically showing a detecting unit and a detection target unit in the second embodiment.

FIG. 24 is a diagram showing the appearance of the cartridge in the second embodiment.

FIG. 25 is a diagram showing the appearance of a cartridge in a third embodiment.

FIG. 26 is a diagram showing the appearance of the cartridge in the third embodiment.

FIG. 27 is a diagram showing the appearance of the cartridge in the third embodiment.

FIG. 28 is a diagram showing the appearance of the cartridge in the third embodiment.

FIG. 29 is a diagram showing the appearance of the cartridge in the third embodiment.

FIG. 30 is a diagram showing the appearance of the cartridge in the third embodiment.

FIG. 31 is a perspective view showing the appearance of the cartridge in the third embodiment.

FIG. 32 is a diagram illustrating a schematic configuration of a liquid supplying unit in Modified Example 1.

FIG. 33 is a diagram showing the appearance of a cartridge in Modified Example 2.

FIG. 34 is a diagram showing the appearance of a cartridge in Modified Example 3.

### DESCRIPTION OF EXEMPLARY EMBODIMENTS

Embodiments of the invention will be described with reference to the drawings by way of example of a liquid ejecting system that includes an inkjet printer (hereinafter, referred to as a printer) serving as an example of a liquid ejecting apparatus. Note that in the drawings, the scales of constituent elements and members may be different in order to have such sizes that allow the constituent elements to be identifiable.

### First Embodiment

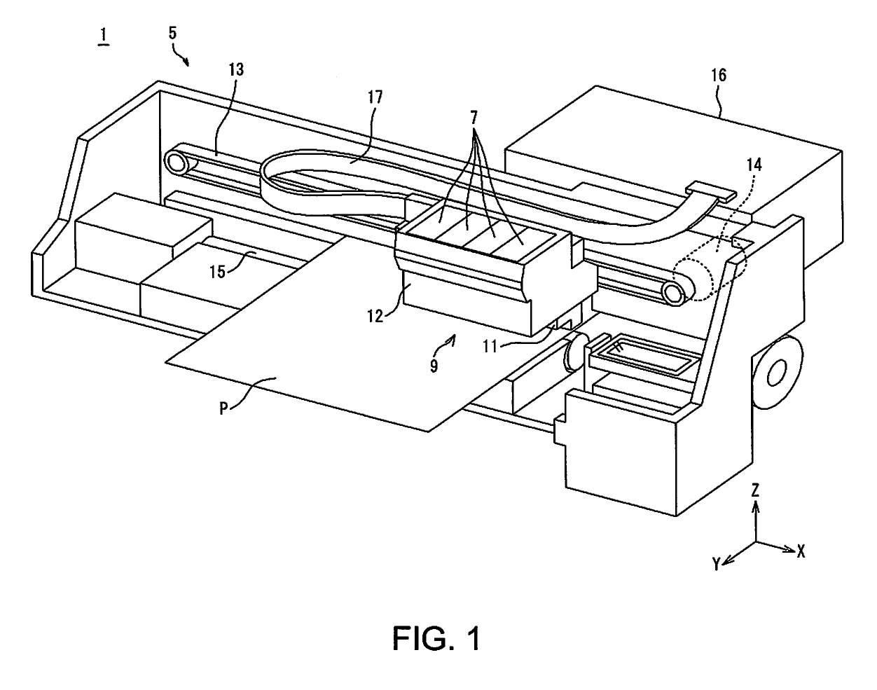

A liquid ejecting system 1 in this embodiment has a printer 5 that is an example of a liquid ejecting apparatus, and a cartridge 7 that is an example of a liquid supplying unit, as shown in FIG. 1. The cartridge 7 can contain ink, which is an example of a liquid. The liquid ejecting system 1 has a plurality of (two or more) cartridges 7. Note that in this embodiment, the printer 5 is equipped with four cartridges 7. The liquid ejecting system 1 can perform printing onto a recording medium P such as recording paper using ink that is an example of liquid. Note that the number of cartridges 7 that can be mounted to the printer 5 is not limited to four, and any suitable number that is one or more can be adopted.

Here, the liquid ejecting system is an apparatus that includes the liquid ejecting apparatus and the liquid supplying unit. The term “liquid ejecting system” is applied in order to clearly distinguish between a liquid ejecting apparatus equipped with a liquid supplying unit and a liquid ejecting apparatus that does not include a liquid supplying unit. Accordingly, an apparatus obtained by removing a liquid supplying unit from a liquid ejecting system is a liquid ejecting apparatus. However, the expression “liquid ejecting apparatus” does not clearly distinguish between the liquid ejecting apparatus equipped with the liquid supplying unit and the liquid ejecting apparatus that does not includes the liquid supplying unit. Accordingly, the concept of the liquid ejecting apparatus encompasses the liquid ejecting apparatus equipped with the liquid supplying unit and the liquid ejecting apparatus that does not have the liquid supplying unit, and this expression can be applied to both.

However, in the present specification, unless particularly stated otherwise, the liquid ejecting apparatus refers to a liquid ejecting apparatus that does not include a liquid supplying unit. Also, in the present specification, the concept of the liquid ejecting system encompass a liquid ejecting apparatus and a liquid supplying unit, and is not applied to a liquid ejecting apparatus that does not include a liquid supplying unit. Note that above-described definition does not deny that both the expression “liquid ejecting system” and the expression “liquid ejecting apparatus equipped with a liquid supplying unit” are used without distinguishing therebetween. Therefore, in the following description, both the expression “liquid ejecting apparatus equipped with a liquid supplying unit” and “liquid ejecting system” may be used without distinguishing therebetween.

According to the above-described definition, the liquid ejecting system 1 in this embodiment is the printer 5 equipped with the cartridge 7. Also, the printer 5 corresponds to an apparatus obtained by removing the cartridge 7 from the liquid ejecting system 1. In FIG. 1, X, Y and Z axes, which are coordinate axes orthogonal to each other, are added. In the figures shown hereinafter, X, Y and Z axes are given as necessary. In this case, the X, Y and Z axes in each figure correspond to the X, Y and Z axes in FIG. 1. FIG. 1 illustrates a state where the liquid ejecting system 1 is arranged on an XY plane defined by the X axis and the Y axis. In this embodiment, a state where the liquid ejecting system 1 is arranged on the XY plane that matches the horizontal plane is a usage state of the liquid ejecting system 1. The orientation of the liquid ejecting system 1 when the liquid ejecting system 1 is arranged on the XY plane matching the horizontal plane is referred to as a usage orientation of the liquid ejecting system 1.

In the following description, the X axis, the Y axis, and the Z axis that are added in figures and description illustrating the constituent elements and units of the liquid ejecting system 1 refer to the X axis, the Y axis, and the Z axis in a state where the constituent elements and units are incorporated (mounted) in the liquid ejecting system 1. Also, the orientation of each constituent element or unit in the usage orientation of the liquid ejecting system 1 is referred to as a usage orientation of the constituent element or unit. In addition, in the following description, description of the liquid ejecting system 1, the constituent elements and units thereof and the like is description in the usage orientation of the liquid ejecting system 1, the constituent elements and units thereof and the like, unless particularly stated otherwise.

The Z axis is an axis orthogonal to the XY plane. In the usage state of the liquid ejecting system 1, the Z axis direction is upward in the vertical direction. In the usage state of the liquid ejecting system 1, in FIG. 1, the −Z axis direction is downward in the vertical direction. Note that regarding each of the X, Y and Z axes, the direction of the arrow indicates a + (positive) direction, and the direction opposite to the direction of the arrow indicates a − (negative) direction. Note that the above-described four cartridges 7 are aligned along the X axis. Therefore, the X axis direction can also be defined as the direction in which the four cartridges 7 are aligned.

The printer 5 has a carriage 9, a recording head 11 and a holder 12. The carriage 9 is configured to be able to reciprocally move along the X axis. The carriage 9 is equipped with the recording head 11 and the holder 12. The recording head 11, which is an example of a liquid ejecting head, is positioned on the −Z axis direction side of the carriage 9. The holder 12 is positioned on the Z axis direction side of the carriage 9. The holder 12 is configured such that a plurality of cartridges 7 can be mounted thereto. The cartridges 7 are removably mounted to the holder 12. The carriage 9 is connected to a timing belt 13. Motive power from a motor 14 is transmitted to the carriage 9 via the timing belt 13. Accordingly, the carriage 9 can reciprocally move along the X axis.

Moreover, in the printer 5, motive power from a conveyance motor (not illustrated) is transmitted to a conveyance roller 15. The conveyance roller 15 extends along the X axis. In the printer 5, by rotating the conveyance roller 15 using the motive power from the conveyance motor, the recording medium P can be conveyed in the Y axis direction.

Ink in the cartridge 7 mounted to the holder 12 is supplied to the recording head 11. A nozzle opening (not illustrated) that is open toward the recording medium P side is formed on the recording head 11. The ink supplied from the cartridges 7 to the recording head 11 is discharged as ink droplets from the nozzle opening of the recording head 11 toward the recording medium P.

The printer 5 is further provided with a control unit 16 for controlling the above-described mechanisms. The recording head 11 is connected to the control unit 16 via a flexible cable 17. In the liquid ejecting system 1 configured as described above, recording is performed onto the recording medium P by causing the recording head 11 to discharge ink droplets at a predetermined position while conveying the recording medium P in the Y axis direction and reciprocally moving the carriage 9 along the X axis.

Here, a direction along the X axis is not limited to a direction perfectly parallel to the X axis, and includes directions inclined due to error, tolerance and the like, except for the direction orthogonal to the X axis. Similarly, a direction along the Y axis is not limited to a direction perfectly parallel to the Y axis, and includes directions inclined due to error, tolerance and the like, except for the direction orthogonal to the Y axis. A direction along the Z axis is not limited to a direction perfectly parallel to the Z axis, and includes directions inclined due to error, tolerance and the like, except for the direction orthogonal to the Z axis. Accordingly, a direction along any axis and plane is not limited to a direction perfectly parallel to that axis and plane, and includes directions inclined due to error, tolerance and the like, except for the direction orthogonal to the axis and plane.

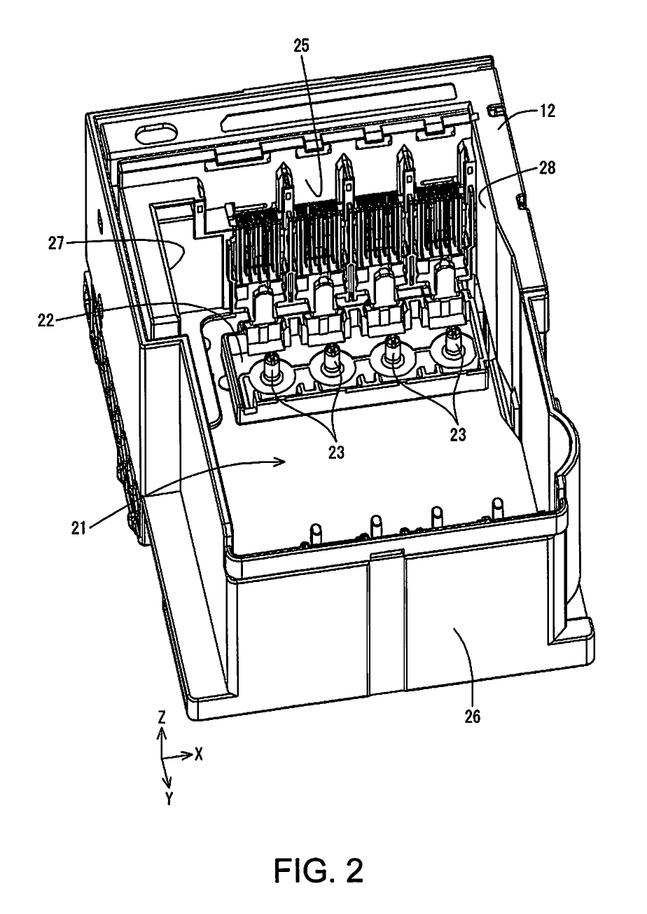

The holder 12 has a recess portion 21 as shown in FIG. 2. The cartridges 7 are mounted in the recess portion 21 of the holder 12. In this embodiment, four cartridges 7 can be housed in the recess portion 21. In this embodiment, the four cartridges 7 mounted in the recess portion 21 are housed with gaps therebetween in the recess portion 21. In the recess portion 21, mounting positions respectively corresponding to the four cartridges 7 that are mounted in the recess portion 21 are specified. The four mounting positions are aligned along the X axis in the recess portion 21. Accordingly, the four cartridges 7 are housed in the recess portion 21 in a state of being aligned along the X axis.

Four ink introduction needles 23 are provided on a bottom portion 22 in the recess portion 21. The ink introduction needle 23 is an example of a liquid introduction needle. The number of ink introduction needles 23 provided in the recess portion 21 is the same as the number of cartridges 7 that can be mounted to the holder 12. The four ink introduction needles 23 protrude from the bottom portion 22 in the Z axis direction. The four ink introduction needles 23 are aligned along the X axis. Ink contained in the cartridges 7 is supplied from the ink introduction needles 23 to the printer 5. Specifically, the ink contained in the cartridges 7 is supplied to the recording head 11 (FIG. 1) via the ink introduction needles 23.

The holder 12 has a side wall 25, a side wall 26, a side wall 27 and a side wall 28. The side wall 25, the side wall 26, the side wall 27 and the side wall 28 each intersect the bottom portion 22 and protrude from the bottom portion 22 in the Z axis direction.

The side wall 25 and the side wall 26 oppose each other along the Y axis such that the ink introduction needle 23 is positioned therebetween. The side wall 25 is positioned in the −Y axis direction relative to the ink introduction needle 23. Also, the side wall 26 is positioned in the Y axis direction relative to the ink introduction needle 23. The side wall 27 and the side wall 28 oppose each other along the X axis such that the ink introduction needle 23 is positioned therebetween. The side wall 27 is positioned in the −X axis direction relative to the ink introduction needle 23. Also, the side wall 28 is positioned in the X axis direction relative to the ink introduction needle 23. The bottom portion 22 is surrounded by the side wall 25, the side wall 26, the side wall 27 and the side wall 28. The recess portion 21 is defined in this manner.

Note that the bottom portion 22 and the side walls 25 to 28 are not limited to a flat wall, and may include recessions and protrusions, or may include a curved surface. Also, the side walls 25 to 28 do not need to be orthogonal to the bottom portion 22, and it suffices for those side walls to intersect the bottom portion 22. Moreover, two surfaces intersecting each other indicates a positional relationship in which the two surfaces are not parallel to each other. In addition to a case where two surfaces are in direct contact with each other, a positional relationship in which two surfaces are not in direct contact and are separated, and a relationship in which an extension of one surface and an extension of the other surface intersect each other are also expressed as “intersecting”. The angle formed by two intersecting surfaces may be any of a right angle, an obtuse angle, and an acute angle.

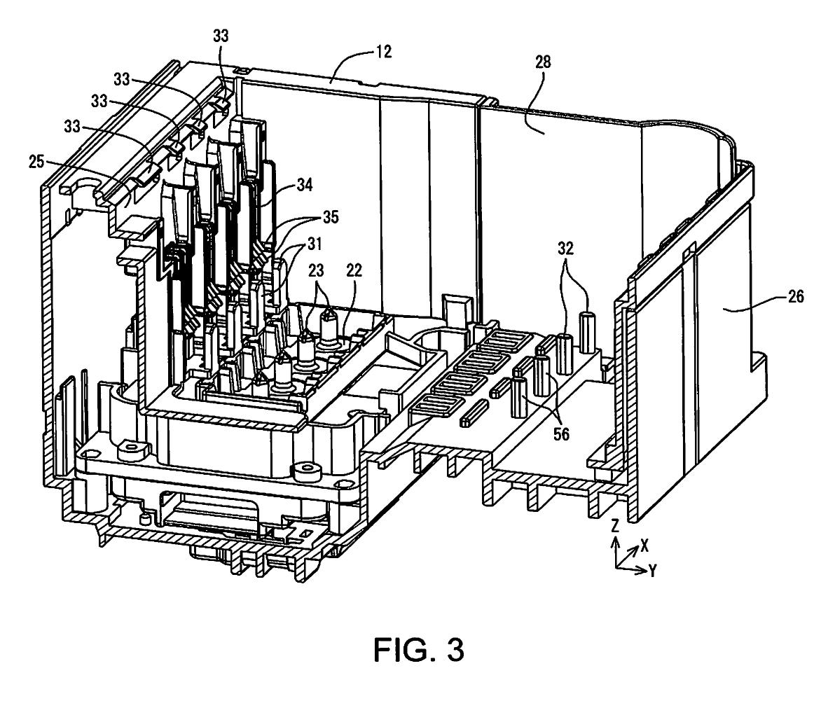

The holder 12 has first projections 31, second projections 32, engaging portions 33 and contact mechanisms 34 as shown in FIG. 3. In order to clearly illustrate the configuration, FIG. 3 shows a state where a portion of the holder 12 is cut away. The first projections 31, the second projections 32, the engaging portions 33 and the contact mechanisms 34 are provided respectively in correspondence with the cartridges 7 that can be mounted to the holder 12. Specifically, in this embodiment, the holder 12 has four first projections 31, four second projections 32, four engaging portions 33 and four contact mechanisms 34. The four first projections 31 are aligned along the X axis. The four second projections 32 are aligned along the X axis. The four engaging portions 33 are aligned along the X axis. The four contact mechanisms 34 are aligned along the X axis.

The first projections 31 and the second projections 32 each protrude from the bottom portion 22 in the Z axis direction. The first projections 31 and the second projections 32 each protrude farther than the ink introduction needles 23 in the Z axis direction. In a planar view of the holder 12 in the −Z axis direction, the first projections 31 are positioned in the −Y axis direction relative to the ink introduction needles 23, and are positioned in the Y axis direction relative to the side wall 25. In a planar view of the holder 12 in the −Z axis direction, the second projections 32 are positioned in the Y axis direction relative to the ink introduction needles 23, and are positioned in the −Y axis direction relative to the side wall 26.

The engaging portions 33 are provided in the side wall 25. The engaging portions 33 are provided at the end portion in the Z axis direction of the side wall 25. The engaging portions 33 protrude from the side wall 25 in the Y axis direction. The engaging portions 33 are configured to be engageable with engagement portions (to be described later) of the cartridges 7. The engagement portions of the cartridges 7 engage with the engaging portions 33 of the holder 12, and thereby the cartridges 7 are mounted to the holder 12.

The side wall 25 is provided with the contact mechanisms 34. In the side wall 25, the contact mechanisms 34 are positioned between the bottom portion 22 and the engaging portions 33. Each contact mechanism 34 has a plurality of electrode pins 35. The electrode pin 35 is an example of an electrode. The contact mechanism 34 constitutes a connection portion that is electrically connectable to a circuit substrate (to be described later) of the cartridge 7. The circuit substrate of the cartridge 7 can be electrically connected to the control unit 16 of the printer 5 via the contact mechanism 34.

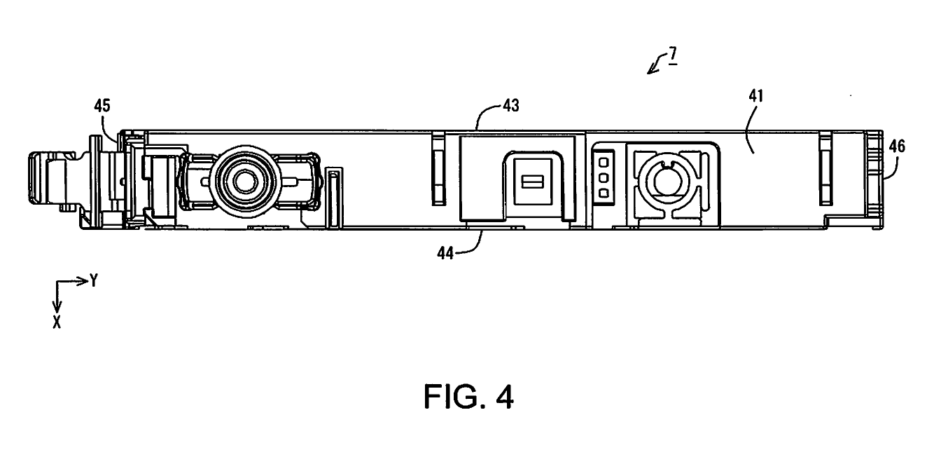

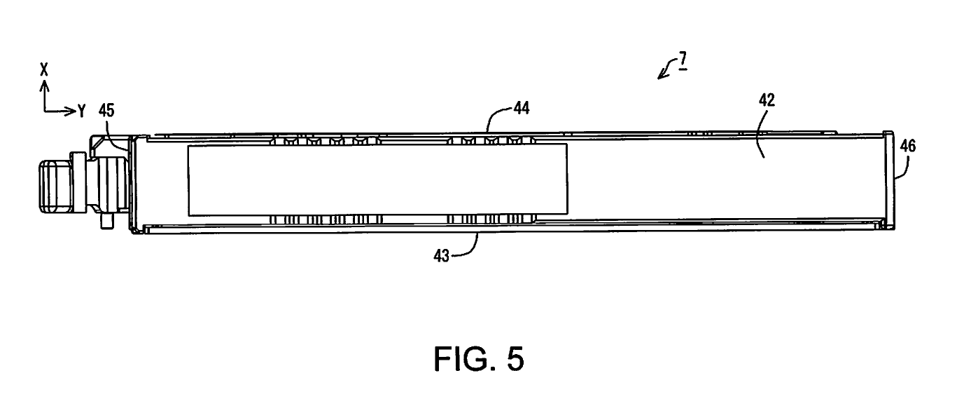

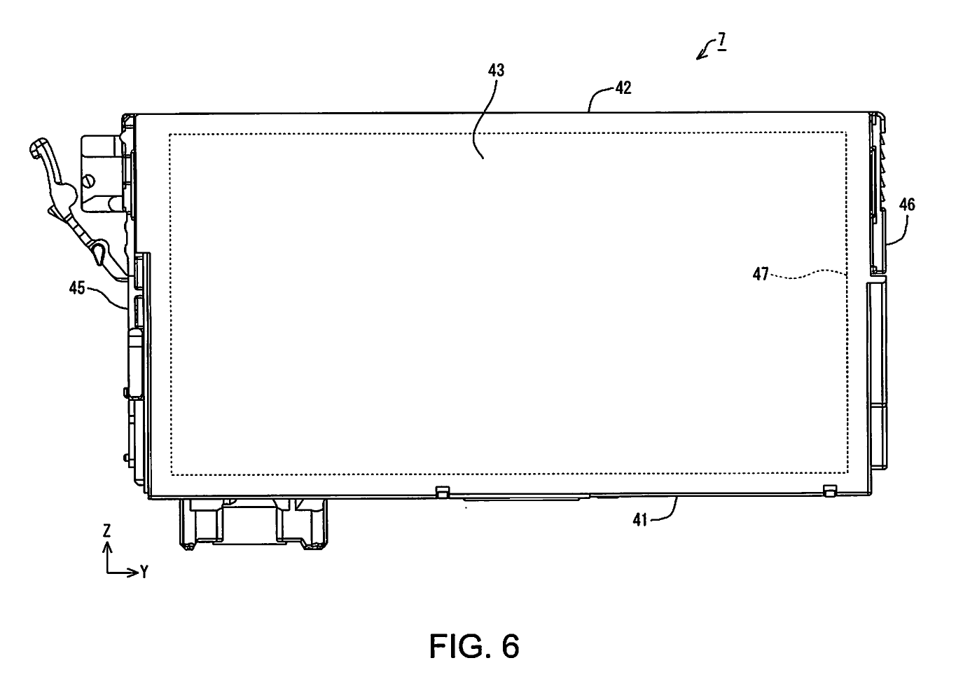

The cartridge 7 will be described. The cartridge 7 has a first wall portion 41, as shown in FIG. 4. FIG. 4 illustrates a state where the cartridge 7 is seen in a planar view in the Z axis direction. The cartridge 7 also has a second wall portion 42 as shown in FIG. 5. FIG. 5 illustrates a state where the cartridge 7 is seen in a planar view in the −Z axis direction. Also, the cartridge 7 has a third wall portion 43 as shown in FIG. 6. FIG. 6 illustrates a state where the cartridge 7 is seen in a planar view in the X axis direction.

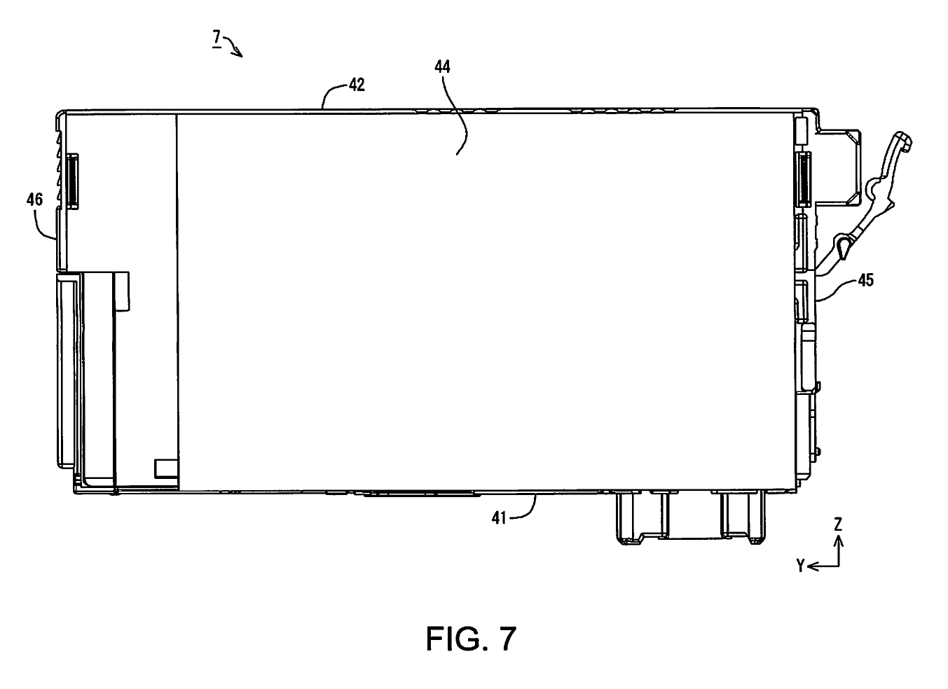

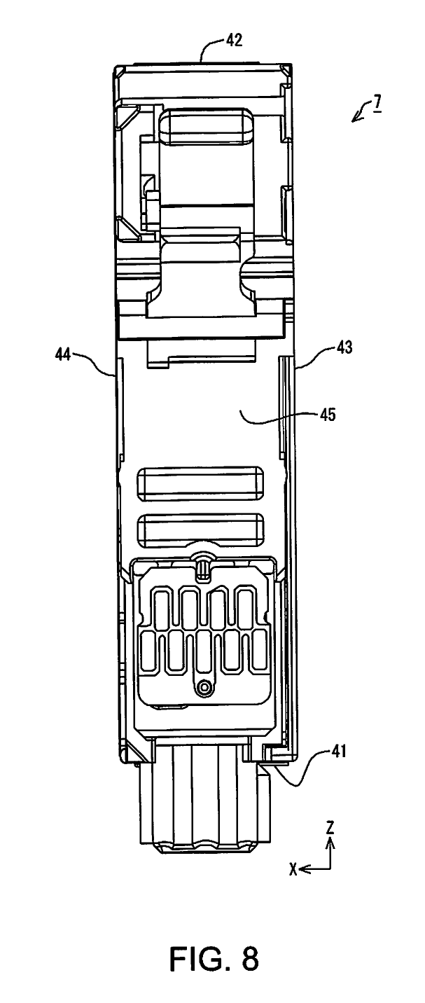

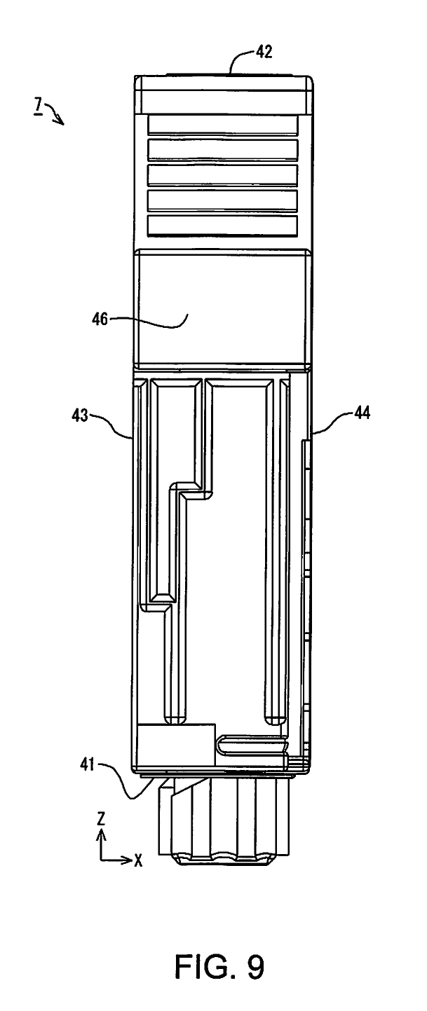

The cartridge 7 also has a fourth wall portion 44 as shown in FIG. 7. FIG. 7 illustrates a state where the cartridge 7 is seen in a planar view in the −X axis direction. The cartridge 7 also has a fifth wall portion 45 as shown in FIG. 8. FIG. 8 illustrates a state where the cartridge 7 is seen in a planar view in the Y axis direction. The cartridge 7 also has a sixth wall portion 46 as shown in FIG. 9. FIG. 9 illustrates a state where the cartridge 7 is seen in a planar view in the −Y axis direction. Note that the first to sixth wall portions 41 to 46 are not limited to a flat wall, and may include recessions and protrusions, or may include a curved surface.

The first wall portion 41 and the second wall portion 42 each intersect the Z axis. The first wall portion 41 and the second wall portion 42 oppose each other. The second wall portion 42 is positioned in the Z axis direction relative to the first wall portion 41. The third wall portion 43 and the fourth wall portion 44 each intersect the X axis. The third wall portion 43 and the fourth wall portion 44 oppose each other. The fourth wall portion 44 is positioned in the X axis direction relative to the third wall portion 43.

The fifth wall portion 45 and the sixth wall portion 46 each intersect the Y axis. The fifth wall portion 45 and the sixth wall portion 46 oppose each other. The sixth wall portion 46 is positioned in the Y axis direction relative to the fifth wall portion 45. The first wall portion 41 and the second wall portion 42 each intersect the third wall portion 43 to the sixth wall portion 46. The third wall portion 43 and the fourth wall portion 44 each intersect the fifth wall portion 45 and the sixth wall portion 46.

A liquid container 47 shown in FIG. 6 is formed in the region surrounded by the first to sixth wall portions 41 to 46 of the cartridge 7. In the cartridge 7, ink is contained in the liquid container 47. Accordingly, in the cartridge 7, ink is contained in the region surrounded the first to sixth wall portions 41 to 46.

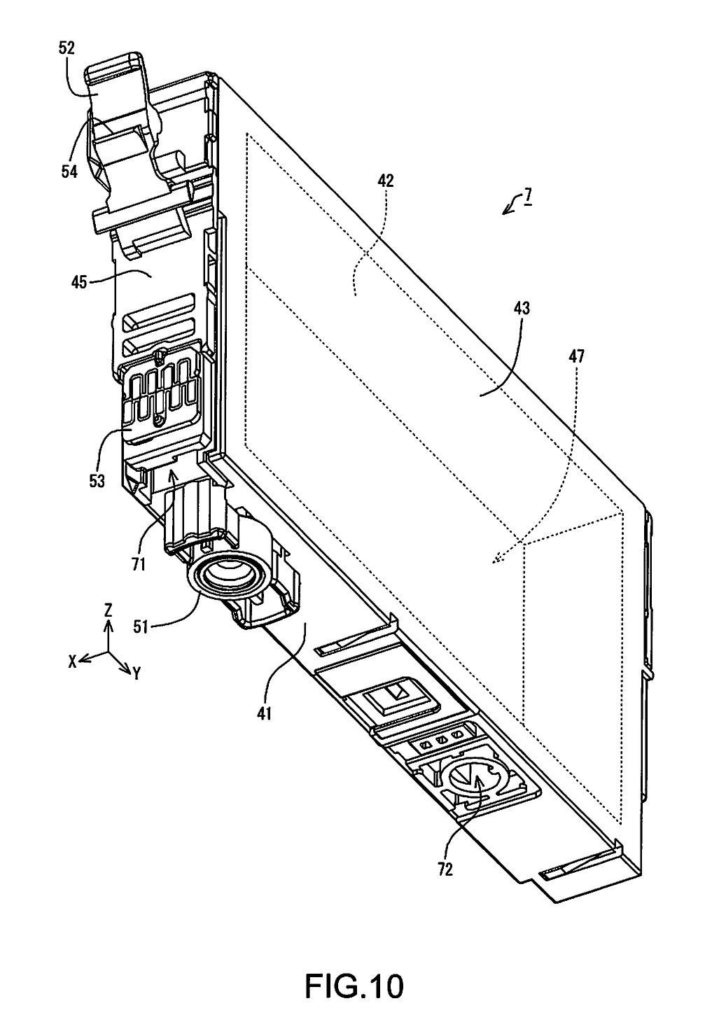

As shown in FIG. 10, a liquid supplying portion 51 is provided in the first wall portion 41. The ink in the liquid container 47 of the cartridge 7 is supplied to the ink introduction needle 23 (FIG. 3) of the holder 12 via the liquid supplying portion 51. In addition, a lever 52 and a circuit substrate 53 are provided on the fifth wall portion 45. The lever 52 protrudes from the fifth wall portion 45 in the −Y axis direction, and extends in the Z axis direction.

The lever 52 is provided with the above-described engagement portion 54. The engagement portion 54 is formed on a portion of the lever 52 that faces the side opposite to the fifth wall portion 45 side, and protrudes in the direction opposite to the fifth wall portion 45 side. The end portion on the Z axis direction side of the engagement portion 54 engages with the end portion in the −Z axis direction of the engaging portion 33 (FIG. 3) of the holder 12, and thereby the cartridge 7 is mounted to the holder 12. Accordingly, the end portion on the Z axis direction side of the engagement portion 54 engages with the end portion on the −Z axis direction side of the engaging portion 33, thereby enabling the displacement of the cartridge 7 relative to the carriage 9 to be regulated. Note that the lever 52 is an example of an engagement structure, and the engagement portion 54 is an example of a portion that can abut on the carriage 9.

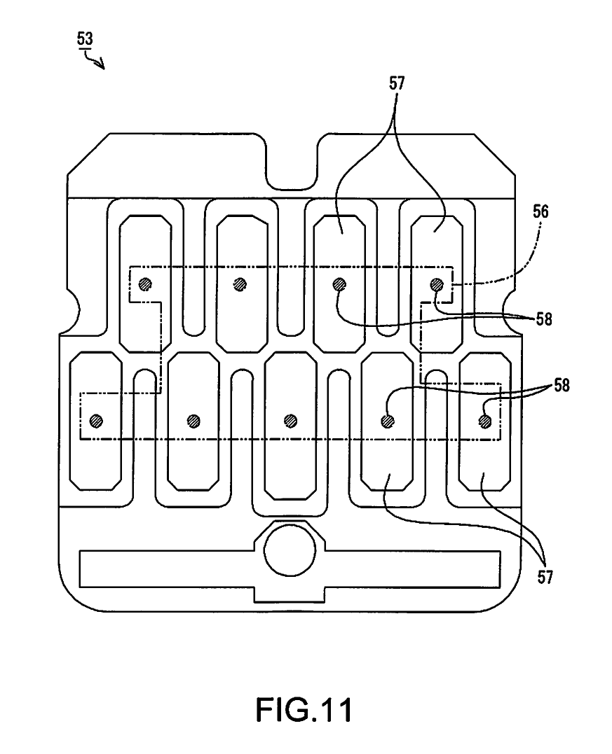

The circuit substrate 53 has a terminal portion 56 as shown in FIG. 11. The circuit substrate 53 has a plurality of terminals 57. The terminals 57 have contact portions 58 that can be in electric contact with the electrode pins 35 of the contact mechanism 34. The terminal portion 56 refers to the function structure that includes a plurality of contact portions 58 that can be in electric contact with the electrode pins 35 of the contact mechanism 34. The terminal portion 56 may be provided on the substrate. In this embodiment, at least some of the plurality of terminals 57 are connected to a storage apparatus (not illustrated) provided on the circuit substrate 53. Moreover, as an example of the plurality of terminals 57, in this embodiment, a configuration is adopted in which a plurality of metal pads are aligned as the terminals 57 on the circuit substrate 53. Also, in a state where the cartridge 7 is mounted to the holder 12, the storage apparatus provided on the circuit substrate 53 of the cartridge 7 and the control unit 16 (FIG. 1) of the printer 5 are electrically connected to each other via the contact mechanism 34. Accordingly, various types of information are exchanged between the storage apparatus provided on the circuit substrate 53 of the cartridge 7 and the control unit 16 of the printer 5.

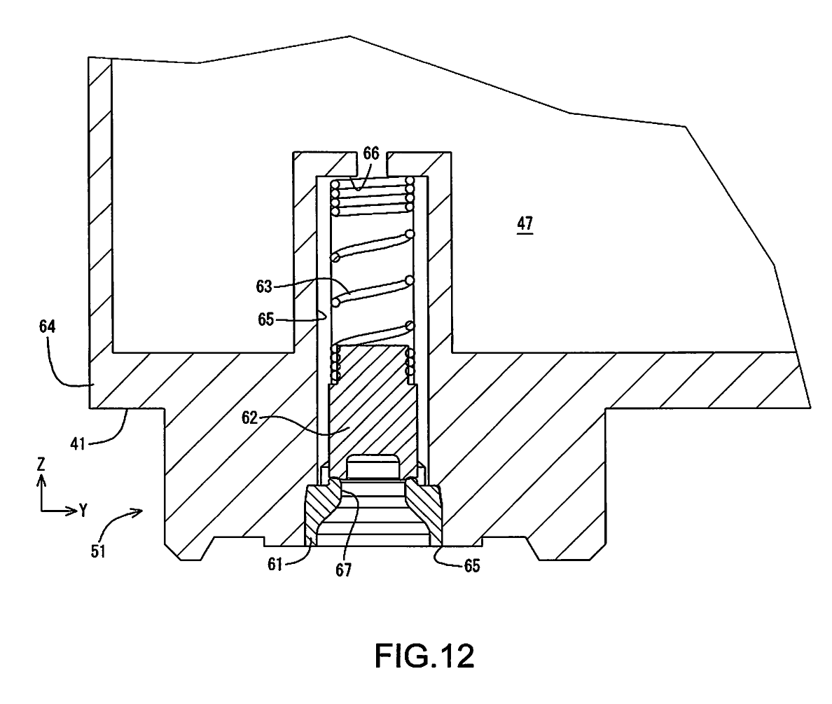

The liquid supplying portion 51 has a sealing member 61, a valve body 62 and a spring 63 as shown in FIG. 12. A case 64 that constitutes the shell of the cartridge 7 has a supply port 65 formed therein. The supply port 65 is formed in the first wall portion 41. The supply port 65 leads to the liquid container 47 through the first wall portion 41. The sealing member 61, the valve body 62 and the spring 63 are housed in the supply port 65. Note that FIG. 12 shows a cross section of the liquid supplying portion 51 that is cut along the YZ plane.

The spring 63, the valve body 62 and the sealing member 61 are housed in the supply port 65 in this order in a direction from the supply port 65 toward the inside of the liquid container 47. The spring 63 is positioned on the liquid container 47 side relative to the valve body 62. The valve body 62 is positioned on the liquid container 47 side relative to the sealing member 61. The spring 63 is positioned between a spring fixing portion 66 and the valve body 62. The valve body 62 is positioned between the spring 63 and the sealing member 61. Therefore, the valve body 62 is biased by the spring 63 toward the sealing member 61 side.

The sealing member 61 is constituted by an elastic body made of rubber, an elastomer or the like. The sealing member 61 is press-fitted in the supply port 65. The sealing member 61 is provided with a through hole 67. The internal diameter of the through hole 67 is smaller than the external diameter of the ink introduction needle 23.

In a state of overlapping the through hole 67 of the sealing member 61, the valve body 62 is biased toward the sealing member 61 side. Therefore, the through hole 67 of the sealing member 61 is blocked by the valve body 62. There is a gap held between the valve body 62 and the supply port 65. There is also a gap held between the spring 63 and the supply port 65. Therefore, the valve body 62 and the spring 63 can each be displaced in the supply port 65 along the extension direction of the supply port 65. Moreover, in a state where the valve body 62 is housed in the supply port 65, a gap between the valve body 62 and the inside of the supply port 65 functions as an ink flow passage.

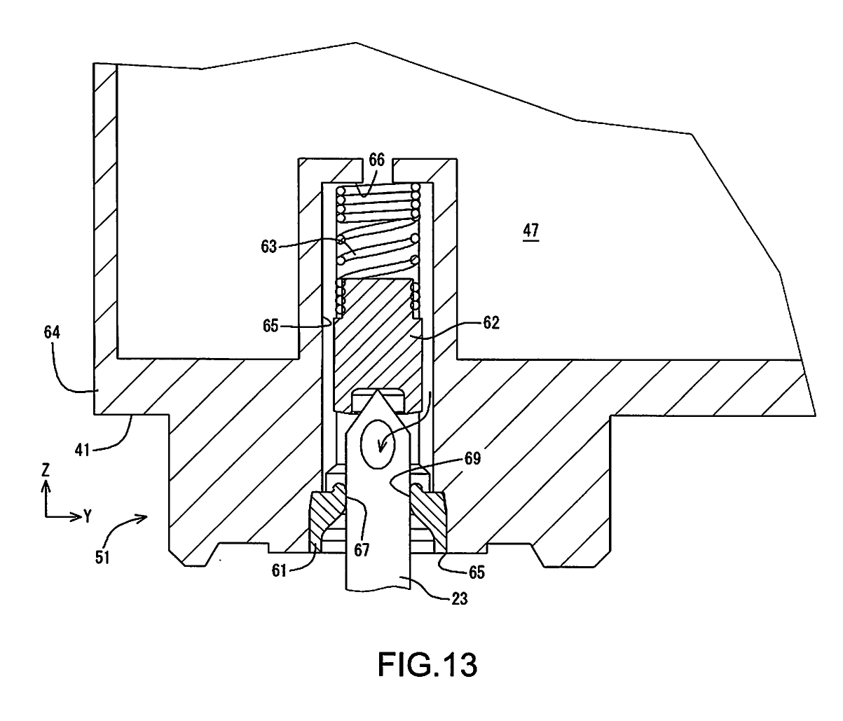

When the cartridge 7 is mounted to the holder 12 (FIG. 3), as shown in FIG. 13, the ink introduction needle 23 is inserted into the through hole 67 of the sealing member 61. At this time, the valve body 62 is pressed by the ink introduction needle 23, and is displaced toward the spring fixing portion 66 side. The ink introduction needle 23 is formed to be hollow. Accordingly, as indicated by the arrow in the figure, ink can be supplied from the flow passage between the inside of the supply port 65 and the valve body 62 to the recording head 11 via the ink introduction needle 23 (FIG. 1).

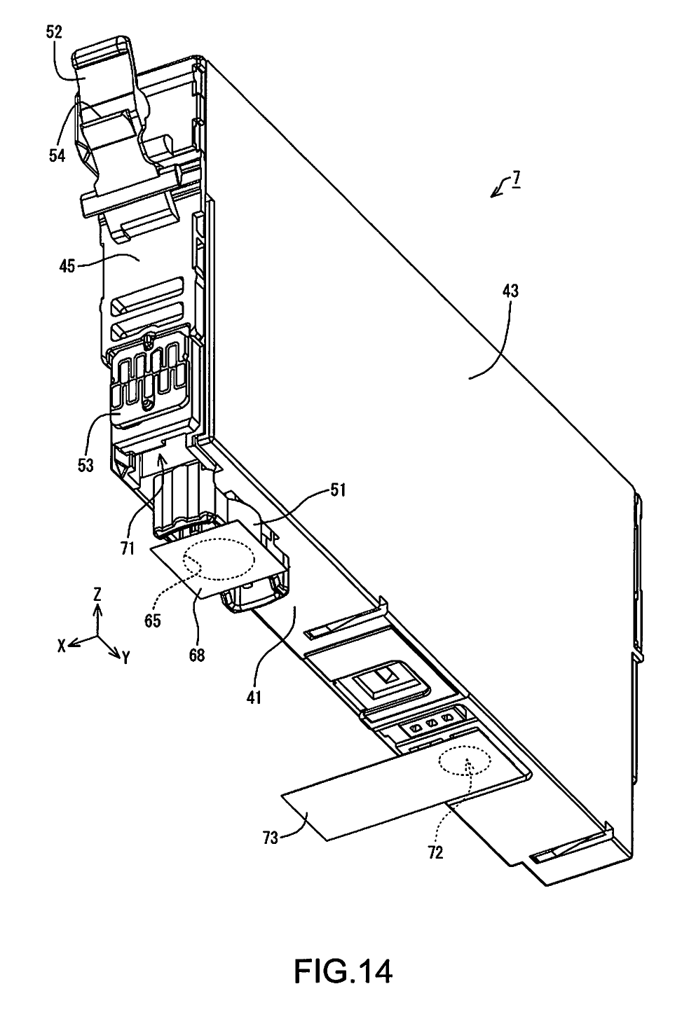

Note that at a stage before the cartridge 7 is mounted to the holder 12, the supply port 65 is sealed by a film 68 as shown in FIG. 14. If the cartridge 7 is mounted to the holder 12 in the state where the supply port 65 is sealed by the film 68, the ink introduction needle 23 breaks the film 68, and the ink introduction needle 23 is then inserted into the liquid supplying portion 51. In addition, as described above, the internal diameter of the through hole 67 of the sealing member 61 is smaller than the external diameter of the ink introduction needle 23. Therefore, when the ink introduction needle 23 is inserted into the liquid supplying portion 51, the ink introduction needle 23 is press-fitted in the sealing member 61. At this time, as shown in FIG. 13, a portion of the sealing member 61 that comes into contact with the ink introduction needle 23 is referred to as an abutment portion 69. The abutment portion 69 corresponds to a portion of the liquid supplying portion that can abut on the liquid introduction needle.

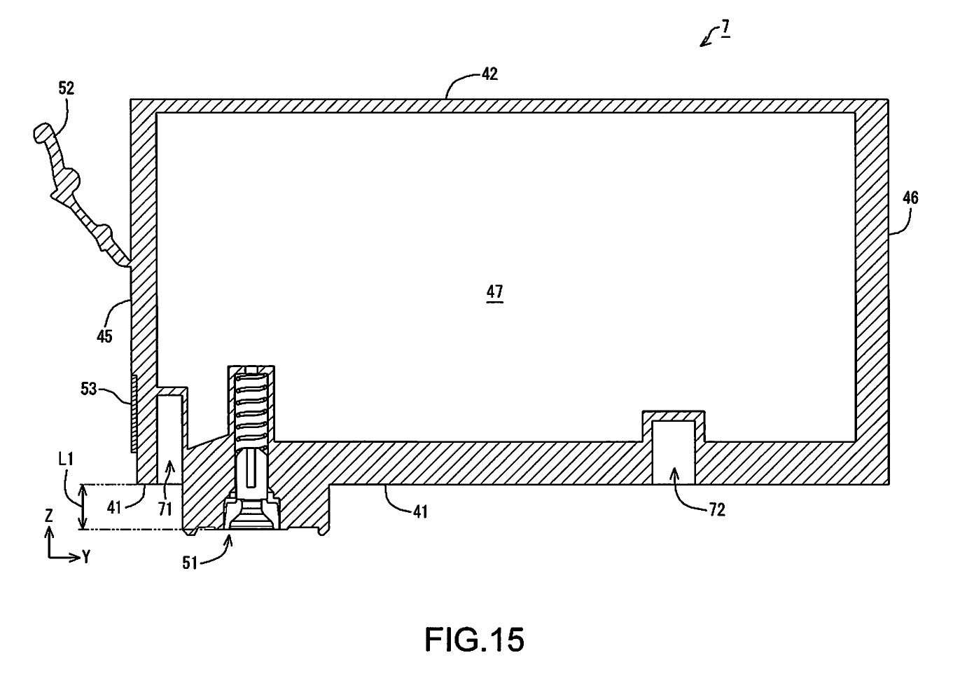

Moreover, in the cartridge 7, a first recess portion 71 and a second recess portion 72 are formed in the first wall portion 41 as shown in FIG. 10. As shown in FIG. 15, the first recess portion 71 and the second recess portion 72 are each provided in such a direction to be recessed from the first wall portion 41 toward the second wall portion 42, in other words, to be recessed in the Z axis direction. The first recess portion 71 and the second recess portion 72 are each open in the −Z axis direction. Note that FIG. 15 shows a cross section of the cartridge 7 that is cut along a YZ plane intersecting the first recess portion 71, the second recess portion 72 and the liquid supplying portion 51.

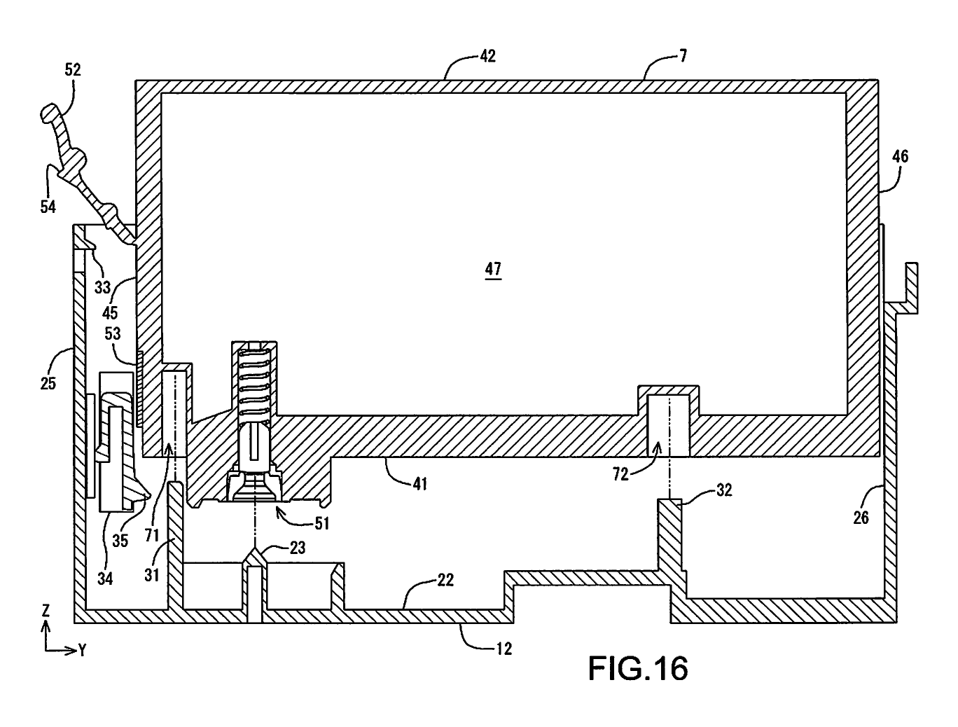

At the stage before the cartridge 7 is mounted to the holder 12, the second recess portion 72 is blocked by a film 73 as shown in FIG. 14. When mounting the cartridge 7 to the holder 12, the user peels off the film 73 from the cartridge 7, and then mounts the cartridge 7 to the holder 12. At this time, as shown in FIG. 16, the first projection 31 of the holder 12 corresponds to the first recess portion 71, and the second projection 32 corresponds to the second recess portion 72. In other words, the first projection 31 of the holder 12 is provided at a position corresponding to the first recess portion 71 of the cartridge 7. Also, the second projection 32 of the holder 12 is provided at a position corresponding to the second recess portion 72 of the cartridge 7.

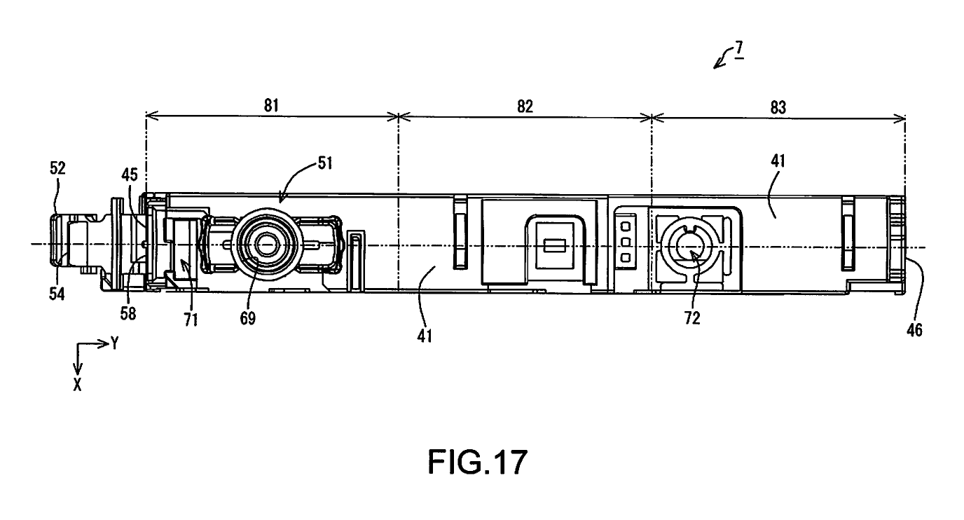

Here, in the cartridge 7, in a planar view of the first wall portion 41 in a first direction from the first wall portion 41 toward the second wall portion 42, in other words, in a planar view of the first wall portion 41 in the Z axis direction, the liquid supplying portion 51 is positioned closer to the fifth wall portion 45 than to the sixth wall portion 46 as shown in FIG. 17. Also, the first recess portion 71 is positioned closer to the fifth wall portion 45 than the liquid supplying portion 51, and the second recess portion 72 is positioned closer to the sixth wall portion 46 than the liquid supplying portion 51. Moreover, when the first wall portion 41 is equally divided into a first region 81, a second region 82 and a third region 83 in a direction from the fifth wall portion 45 toward the sixth wall portion 46, in other words, in the Y axis direction, the first recess portion 71 is positioned in the first region 81, and the second recess portion 72 is positioned in the third region 83.

According to the above-described configuration, in the cartridge 7, the first projection 31 can be inserted into the first recess portion 71, and the second projection 32 can be inserted into the second recess portion 72. Therefore, when mounting the cartridge 7 to the holder 12 of the carriage 9, the first recess portion 71 and the second recess portion 72 can be used as guides for the mounting. It is possible to reduce variation in the orientation of the cartridge 7 relative to the carriage 9 when mounting the cartridge 7 to the carriage 9. As a result, it is easy to improve the convenience when mounting the cartridge 7 to the carriage 9.

Moreover, in the cartridge 7, the abutment portion 69 within the sealing member 61 that abuts on the ink introduction needle 23, the contact portion 58 of the circuit substrate 53 (FIG. 11), the first recess portion 71 and the second recess portion 72 are arranged along a straight line as shown in FIG. 17. In the cartridge 7, the abutment portion 69 within the sealing member 61 that abuts on the ink introduction needle 23, the contact portion 58 of the circuit substrate 53 (FIG. 11), the first recess portion 71 and the second recess portion 72 are each one of the factors that regulate the position of the cartridge 7 relative to the carriage 9 when the cartridge 7 is mounted to the carriage 9. By aligning the factors that regulate the position of the cartridge 7 relative to the carriage 9 along a straight line, it is possible to improve a function of guiding the cartridge 7 to the carriage 9 when mounting the cartridge 7 to the carriage 9.

Moreover, in the cartridge 7, the engagement portion 54 of the lever 52, the abutment portion 69 within the sealing member 61 that abuts on the ink introduction needle 23, the first recess portion 71 and the second recess portion 72 are arranged along a straight line as shown in FIG. 17. In the cartridge 7, the engagement portion 54 of the lever 52, the abutment portion 69 within the sealing member 61 that abuts on the ink introduction needle 23, the first recess portion 71 and the second recess portion 72 are each one of the factors that regulate the position of the cartridge 7 relative to the carriage 9 when the cartridge 7 is mounted to the carriage 9. By aligning the factors that regulate the position of the cartridge 7 relative to the carriage 9 along a straight line, it is possible to improve a function of guiding the cartridge 7 to the carriage 9 when mounting the cartridge 7 to the carriage 9.

Also, in the cartridge 7, as shown in FIG. 15, assuming a direction from the second wall portion 42 toward the first wall portion 41 to be a second direction, the liquid supplying portion 51 protrudes farther than a portion of the first wall portion 41 in which the first recess portion 71 is provided, by a first distance L1 in the second direction. In other words, in the cartridge 7, the liquid supplying portion 51 protrudes farther than the first wall portion 41 by the first distance L1 in the −Z axis direction.

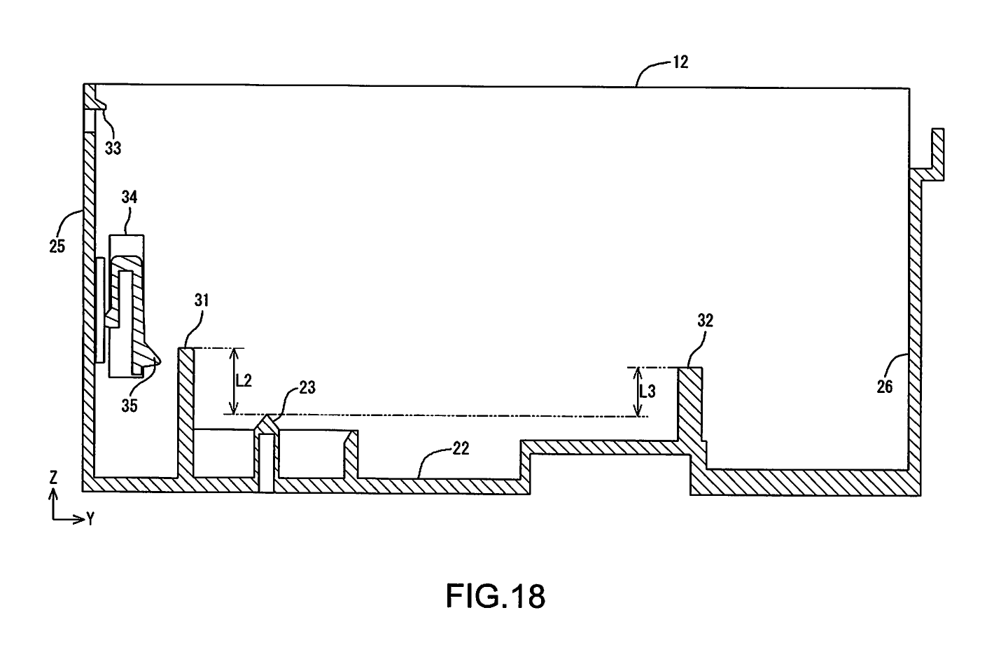

Moreover, in the holder 12, the first projection 31 protrudes farther than the ink introduction needle 23 by a second distance L2 in the Z axis direction as shown in FIG. 18. Note that as described above, the Z axis direction corresponds to the first direction from the first wall portion 41 toward the second wall portion 42 in the cartridge 7. In addition, in this embodiment, the second distance L2 is greater than the first distance L1.

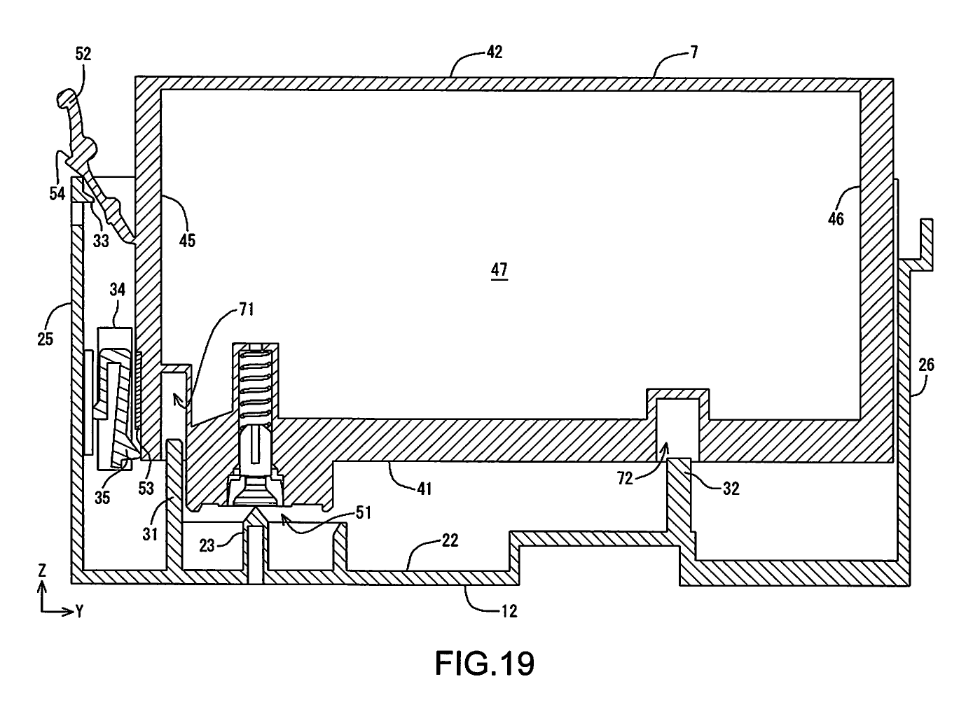

According to such a configuration, as shown in FIG. 19, when the cartridge 7 is mounted to the holder 12 of the carriage 9, the first projection 31 can enter the first recess portion 71 before the ink introduction needle 23 reaches the liquid supplying portion 51. Accordingly, the first projection 31 is likely to enter the first recess portion 71 before the ink introduction needle 23 enters the liquid supplying portion 51. Therefore, when the cartridge 7 is mounted to the holder 12 of the carriage 9, the first recess portion 71 is guided to the first projection 31, making it easy to guide the liquid supplying portion 51 to the ink introduction needle 23. As a result, it is easy to stabilize the orientation of the cartridge relative to the carriage 9 when the ink introduction needle 23 enters the liquid supplying portion 51.

Moreover, in the holder 12, the second projection 32 protrudes farther than the ink introduction needle 23 by a third distance L3 in the Z axis direction as shown in FIG. 18. In addition, in this embodiment, the third distance L3 is greater than the first distance L1. According to such a configuration, as shown in FIG. 19, when the cartridge 7 is mounted to the holder 12 of the carriage 9, the second projection 32 can enter the second recess portion 72 before the ink introduction needle 23 reaches the liquid supplying portion 51. Accordingly, in this embodiment, when the cartridge 7 is mounted to the holder 12 of the carriage 9, it is likely that the first projection 31 enters the first recess portion 71 and the second projection 32 enters the second recess portion 72 before the ink introduction needle 23 reaches the liquid supplying portion 51. Accordingly, when the cartridge 7 is mounted to the holder 12 of the carriage 9, the first recess portion 71 is guided to the first projection 31, and the second recess portion 72 is guided to the second projection 32, thereby making it easy to guide the liquid supplying portion 51 to the ink introduction needle 23. As a result, it is easy to further stabilize the orientation of the cartridge 7 relative to the carriage 9 when the ink introduction needle 23 enters the liquid supplying portion 51.

Moreover, when the cartridge 7 is mounted to the holder 12 of the carriage 9, the electrode pin 35 of the contact mechanism 34 abuts on the fifth wall portion 45 of the cartridge 7, and the electrode pin 35 flexes in the −Y axis direction, as shown in FIG. 19. Note that in the cartridge 7, the first recess portion 71 and the contact portions 58 of the circuit substrate 53 (FIG. 11) are provided at positions at which they oppose each other such that the fifth wall portion 45 is positioned therebetween.

Furthermore, in the holder 12, as shown in FIG. 18, the second distance L2 is greater than the third distance L3. According to such a configuration, as shown in FIG. 19, when the cartridge 7 is mounted to the holder 12 of the carriage 9, the first projection 31 is likely to enter the first recess portion 71 before the second projection 32 enters the second recess portion 72. Therefore, when the cartridge 7 is mounted to the holder 12 of the carriage 9, the first recess portion 71 is likely to be guided to the first projection 31 before the second recess portion 72 is guided to the second projection 32. In other words, the first recess portion 71 is likely to be guided before the second recess portion 72.

In addition, the liquid supplying portion 51 of the cartridge 7 is provided at a position closer to the first recess portion 71 than to the second recess portion 72. Accordingly, the liquid supplying portion 51 is closer to the first recess portion 71 that is likely to be guided before the second recess portion 72. Therefore, when the cartridge 7 is mounted to the holder 12 of the carriage 9, it is easy to guide, at an early stage, the liquid supplying portion 51 that is closer to the first recess portion 71, thus making it easy to stabilize the orientation of the cartridge 7 relative to the carriage 9 when the ink introduction needle 23 enters the liquid supplying portion 51. As a result, when the cartridge 7 is mounted to the holder 12 of the carriage 9, the ink introduction needle 23 is easily inserted into the liquid supplying portion 51 in a stable manner.

Also, the contact portions 58 of the circuit substrate 53 of the cartridge 7 (FIG. 11) are provided on the fifth wall portion 45 that is closer to the first recess portion 71 than to the second recess portion 72. Accordingly, the contact portions 58 are closer to the first recess portion 71 that is likely to be guided before the second recess portion 72. Therefore, when the cartridge 7 is mounted to the holder 12 of the carriage 9, the contact portions 58 that are closer to the first recess portion 71 are likely to be guided at an early stage, and thus it is easy to stabilize the orientation of the cartridge 7 relative to the carriage 9 when the contact portions 58 come into contact with the electrode pins 35 of the contact mechanism 34. As a result, when the cartridge 7 is mounted to the holder 12 of the carriage 9, the contact portions 58 are easily brought into contact with the electrode pins 35 in a stable manner.

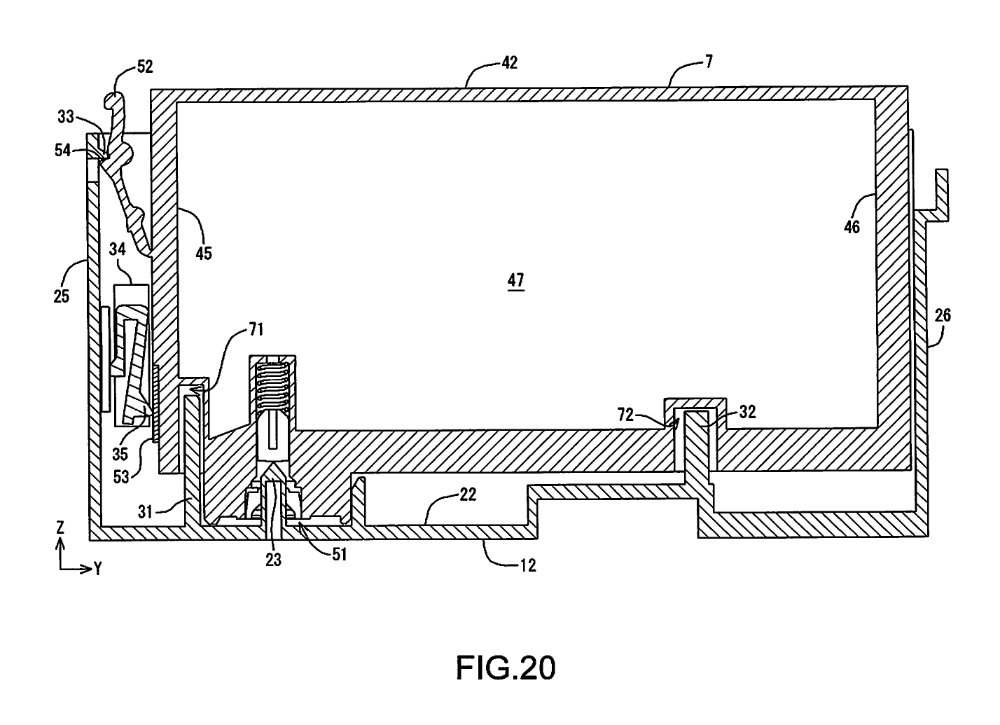

Subsequently, when the cartridge 7 further enters the holder 12, as shown in FIG. 20, the engagement portion 54 of the lever 52 engages with the engaging portion 33 of the holder 12. Accordingly, the cartridge 7 is mounted to the carriage 9. At this time, in the state where mounting of the cartridge 7 to the carriage 9 is complete, a gap is provided between the first projection 31 and the first recess portion 71 in the Z axis direction. Also, a gap is provided between the second projection 32 and the second recess portion 72 in the Z axis direction. With such settings, even if the heights in the Z axis direction of the first projection 31 and the second projection 32 vary due to dimension tolerance or error, it is easy to avoid variation in the position in the Z axis direction of the cartridge 7 relative to the holder 12.

Also, at this time, as shown in FIG. 20, the electrode pin 35 of the contact mechanism 34 abut on the circuit substrate 53 of the cartridge 7, and the electrode pin 35 flexes farther in the −Y axis direction. As described above, in the cartridge 7, the first recess portion 71 and the contact portion 58 of the circuit substrate 53 (FIG. 11) are provided at positions at which they oppose each other such that the fifth wall portion 45 is positioned therebetween. Therefore, when the cartridge 7 is mounted to the holder 12 of the carriage 9, the contact portion 58 of the circuit substrate 53 of the cartridge 7 (FIG. 11) and the fifth wall portion 45 are positioned between the electrode pin 35 of the contact mechanism 34 and the first projection 31.

This makes it easy to further stabilize the orientation of the cartridge relative to the carriage 9 when the cartridge 7 is mounted to the holder 12 of the carriage 9. Therefore, it is easy to stabilize the orientation of the cartridge 7 relative to the carriage 9 when the contact portion 58 comes in to contact with the electrode pin 35 of the contact mechanism 34. As a result, when the cartridge 7 is mounted to the holder 12 of the carriage 9, it is easy to bring the contact portion 58 into contact with the electrode pin 35 in a stable manner.

Moreover, according to this configuration, it becomes easy to prevent the electrode pins 35 of the carriage 9 from being separated from the contact portions 58 of the circuit substrate 53, and prevent these positions from becoming deviated from each other when the cartridge 7 is mounted to the carriage 9 and the carriage 9 is moved. For example, when the printer 5 executes a printing operation, there are cases where vibration or the like is applied to the cartridge 7 in accordance with reciprocal movement of the carriage 9, and even in such a situation, it becomes possible to appropriately maintain the connection relationship between the electrode pins 35 of the carriage 9 and the contact portions 58 of the cartridge 7.

Note that a configuration in which the first projection 31 and the first recess portion 71 abut on each other in the Z axis direction, and a configuration in which the second projection 32 and the second recess portion 72 abut on each other in the Z axis direction can also be adopted. With the configuration in which the first projection 31 and the first recess portion 71 abut on each other in the Z axis direction and the configuration in which the second projection 32 and the second recess portion 72 abut on each other in the Z axis direction, it is possible to improve the positional accuracy of the cartridge 7 relative to the holder 12 in the Z axis direction.

In this case, a configuration can be adopted in which the first projection 31 abuts on the first recess portion 71 in the Z axis direction, and a gap in the Z axis direction is provided between the second projection 32 and the second recess portion 72. With this configuration, out of the first recess portion 71 and the second recess portion 72, the first recess portion 71 that is closer to the liquid supplying portion 51 can regulate the position in the Z axis direction of the cartridge 7 relative to the holder 12. This makes it possible to improve the positional accuracy in the Z axis direction of the liquid supplying portion 51 relative to the holder 12.

A configuration can also be adopted in which the second projection 32 abuts on the second recess portion 72 in the Z axis direction, and a gap in the Z axis direction is provided between the first projection 31 and the first recess portion 71. With this configuration, out of the first recess portion 71 and the second recess portion 72, the second recess portion 72 that is farthest away from the liquid supplying portion 51 can regulate the position in the Z axis direction of the cartridge 7 relative to the holder 12. Accordingly, even if the position in the Z axis direction at which the second recess portion 72 abuts on the second projection 32 varies due to dimension tolerance or error, it is possible to reduce variation in the position in the Z axis direction of the liquid supplying portion 51 relative to the holder 12.

In the state where mounting of the cartridge 7 to the carriage 9 is complete, the cartridge 7 can be removed from the holder 12 by releasing the engagement between the engagement portion 54 of the lever 52 and the engaging portion 33 of the holder 12. In this manner, the cartridge 7 is mounted to and removed from the carriage 9.

### Second Embodiment

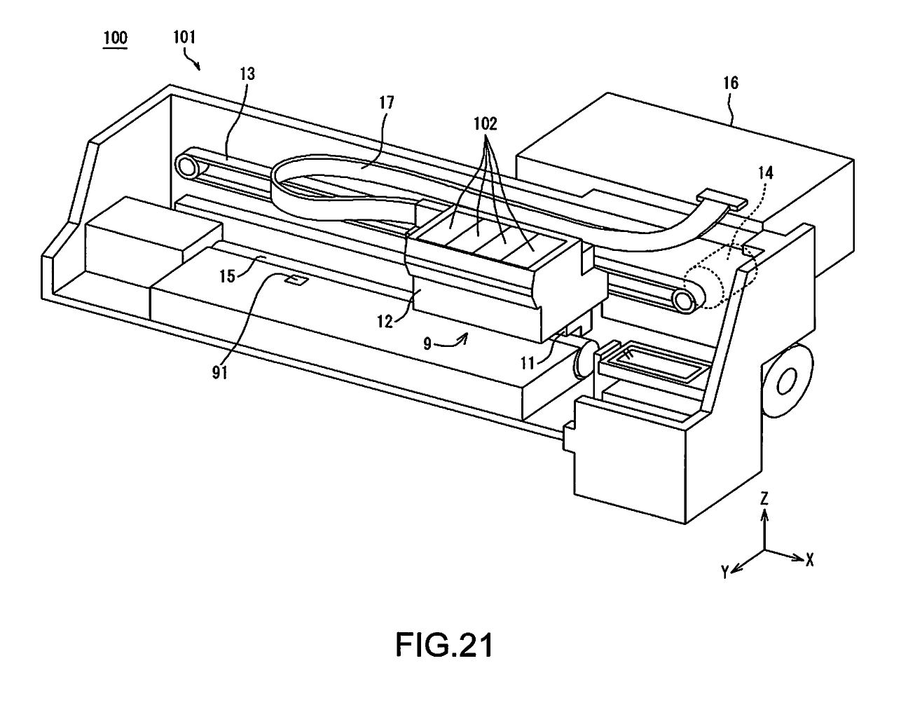

A liquid ejecting system 100 in a second embodiment will be described. The liquid ejecting system 100 has a printer 101 and a cartridge 102 as shown in FIG. 21. The printer 101 has a detecting unit 91. The printer 101 has a configuration in which the detecting unit 91 is added to the printer 5 in the first embodiment. Except for this, the printer 101 has a configuration similar to that of the printer 5. Therefore, in the following description, the same reference signs as those of the constituent elements of the printer 5 are given to the constituent elements of the printer 101 that are similar to the constituent elements of the printer 5, and detailed description is omitted.

In this embodiment, the detecting unit 91 can detect the residual quantity of ink in the cartridge 102. In this embodiment, a configuration is adopted in which the residual quantity of ink in the cartridge 102 is optically detected. With this configuration, the detecting unit 91 has an optical element. In this embodiment, as an example of the optical element, an optical sensor that has a light-emitting element and a light receiving element is adopted. In this optical sensor, when the light receiving element detects light from the light-emitting element, a detection signal of a high level is output (ON state), and when the light receiving element does not detect light from the light-emitting element, a detection signal of a low level is output (OFF state). Note that the ON state and the OFF state may be reversed.

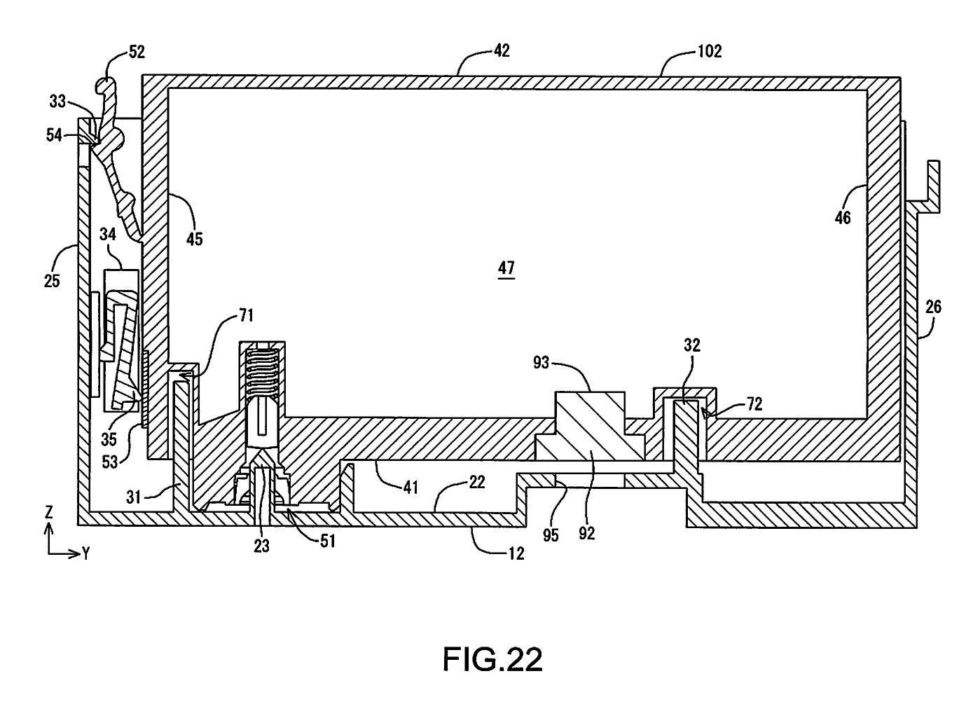

The cartridge 102 has a detection target unit 92 as shown in FIG. 22. The cartridge 102 has a configuration in which the detection target unit 92 is added to the cartridge 7 in the first embodiment. Except for this, the cartridge 102 has a configuration similar to that of the cartridge 7. Therefore, in the following description, the same reference signs as those of the constituent elements of the cartridge 7 are given to the constituent elements of the cartridge 102 that are similar to the constituent elements of the cartridge 7, and detailed description is omitted.

The detection target unit 92 has an optical part. In this embodiment, a prism 93 serves as an example of the optical part. The detection target unit 92 is provided in the first wall portion 41 of the cartridge 102. The detection target unit 92 is sunk into the liquid container 47 through the first wall portion 41. In addition, in this embodiment, a window portion 95 is formed in the holder 12. The window portion 95 is formed to pass through the bottom portion 22 of the holder 12. In a state where the cartridge 102 is mounted to the holder 12, the window portion 95 is formed at a position at which it overlaps the detection target unit 92 of the cartridge 102 along the Z axis.

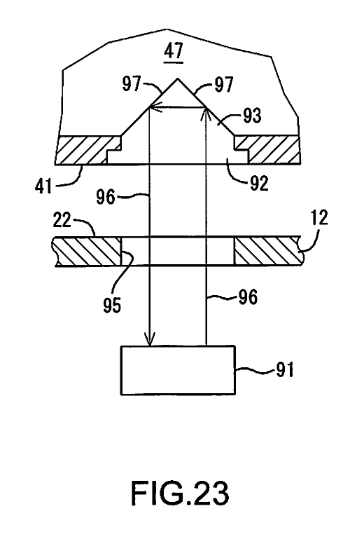

The detecting unit 91 shown in FIG. 21 is provided at a position at which it overlaps the path of the detection target unit 92 when the carriage 9 is moved along the X axis. Detection processing is then performed at a position at which the detection target unit 92 and the detecting unit 91 overlap each other along the Z axis. When detection processing is performed, as shown in FIG. 23, a beam 96 from the light-emitting element of the detecting unit 91 is incident on the prism 93 of the detection target unit 92 via the window portion 95. At this time, if the liquid level of ink in the liquid container 47 is higher than a reflective face 97, the beam 96 that is incident on the prism 93 exits the prism 93 from the reflective face 97. Therefore, if the liquid level of the ink in the liquid container 47 is higher than the reflective face 97, the optical sensor of the detecting unit 91 enters the OFF state.

On the other hand, if the liquid level of the ink in the liquid container 47 is lower than the reflective face 97, the beam 96 that is incident on the prism 93 is reflected by the reflective face 97 and then exits the prism 93 toward the detecting unit 91. Therefore, if the liquid level of the ink in the liquid container 47 is lower than the reflective face 97, the optical sensor of the detecting unit 91 enters the ON state. Such change of the detecting unit 91 between the ON state and the OFF state makes it possible to detect the residual quantity of the ink in the liquid container 47.

Also in the second embodiment, an effect similar to that of the first embodiment can be obtained. Moreover, in the second embodiment, the residual quantity of ink contained in the cartridge 102 can be detect, and thus the convenience of the liquid ejecting system 100 improves.

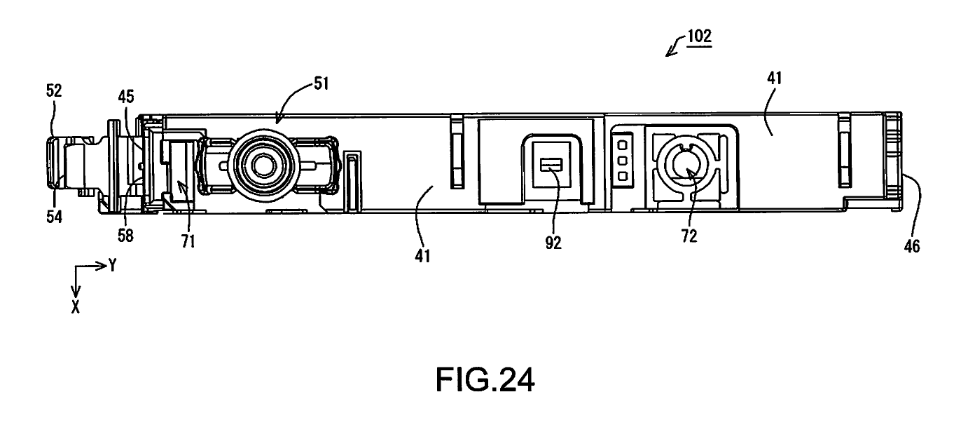

In the second embodiment, the detection target unit 92 of the cartridge 102 is positioned between the first recess portion 71 and the second recess portion 72. Specifically, in a planar view of the first wall portion 41 in a direction from the first wall portion 41 toward the second wall portion 42 (the Z axis direction), as shown in FIG. 24, the detection target unit 92 is positioned between the first recess portion 71 and the second recess portion 72.

According to such a configuration, in the liquid ejecting system 100, the first projection 31 can be inserted into the first recess portion 71 of the cartridge 102, and the second projection 32 can be inserted into the second recess portion 72. Therefore, when the cartridge 102 is mounted to the holder 12 of the carriage 9, the position of the first recess portion 71 can be regulated by the first projection 31, and the position of the second recess portion 72 can be regulated by the second projection 32. As a result, it is possible to reduce variation in the orientation of the cartridge 102 relative to the carriage 9 after the cartridge 102 is mounted to the holder 12 of the carriage 9. As a result, it is easy to suppress deterioration of the detection accuracy in the detection target unit 92.

### Third Embodiment

A cartridge 200 in a third embodiment will be described. The external dimensions of the cartridge 200 are different from the external dimensions of the cartridge 7 and the cartridge 102. Except for this, the cartridge 200 has a configuration similar to that of the cartridge 7 and the cartridge 102. Therefore, the same reference signs as those of the cartridge 7 and the cartridge 102 are given to the constituent elements of the cartridge 200 similar to those of the cartridge 7 and the cartridge 102, and detailed description is omitted as appropriate.

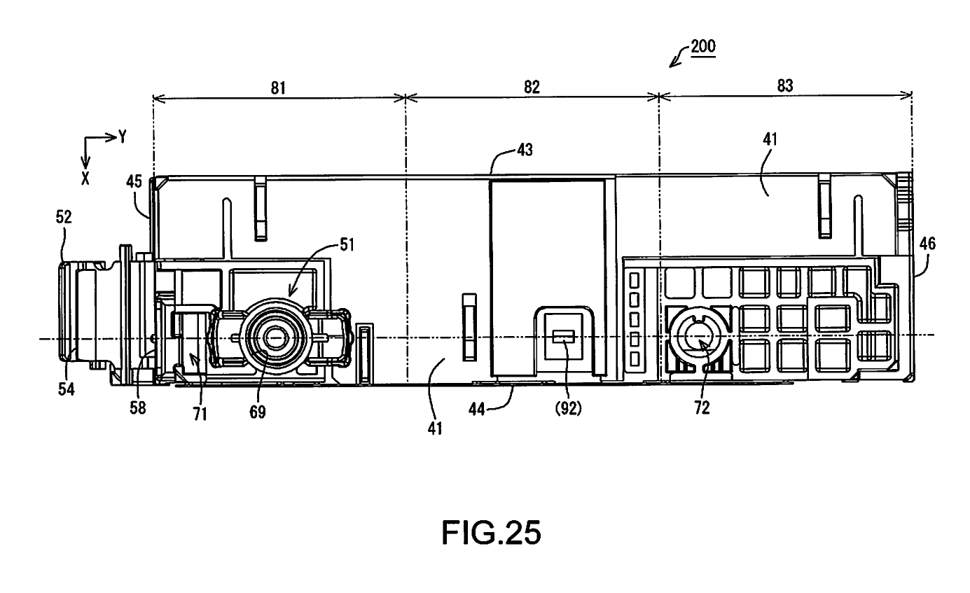

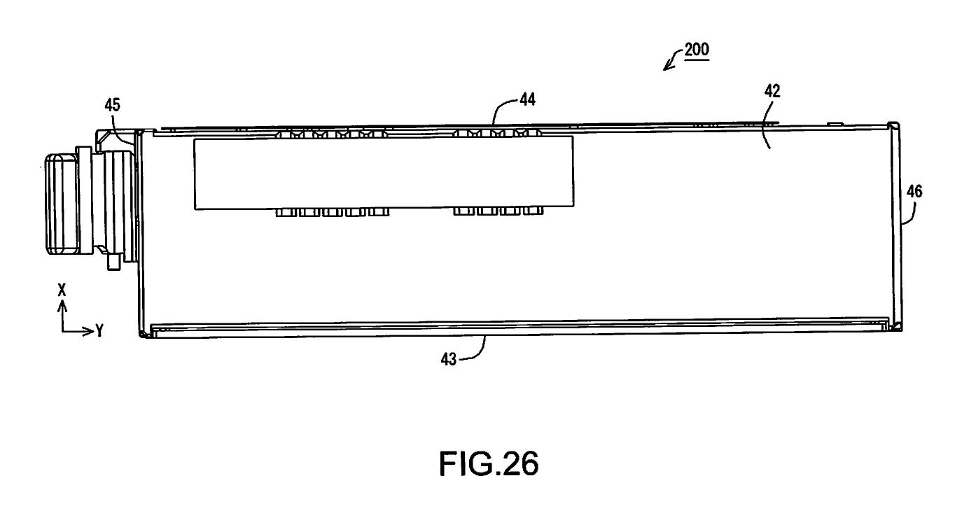

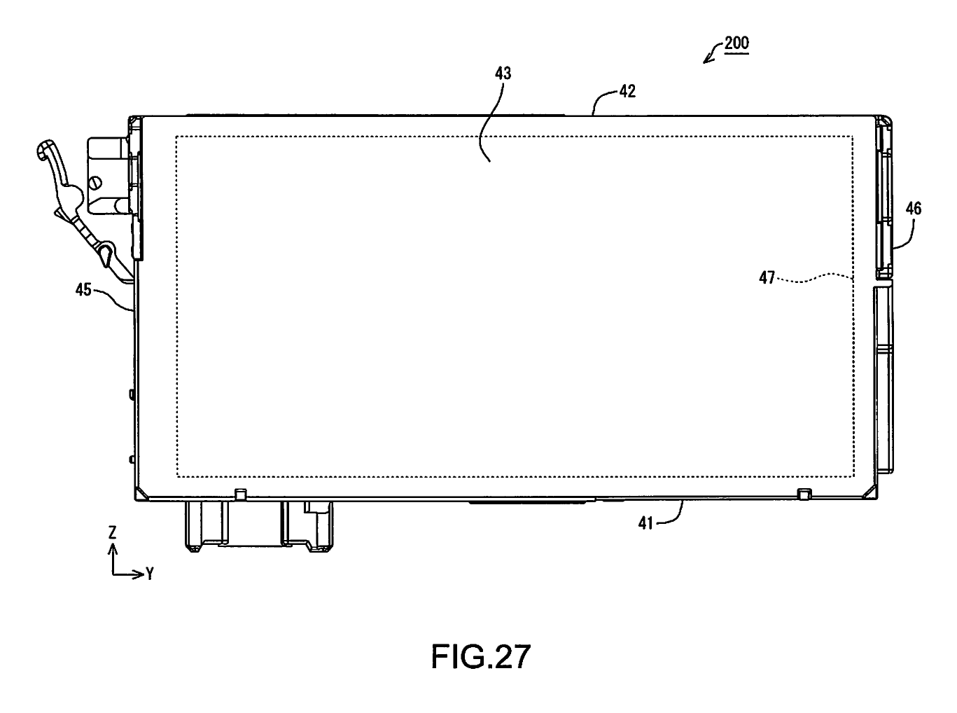

The cartridge 200 has the first wall portion 41 as shown in FIG. 25. FIG. 25 illustrates a state where the cartridge 200 is seen in a planar view in the Z axis direction. The cartridge 200 also has the second wall portion 42 as shown in FIG. 26. FIG. 26 illustrates a state where the cartridge 200 is seen in a planar view in the −Z axis direction. The cartridge 200 also has the third wall portion 43 as shown in FIG. 27. FIG. 27 illustrates a state where the cartridge 200 is seen in a planar view in the X axis direction.

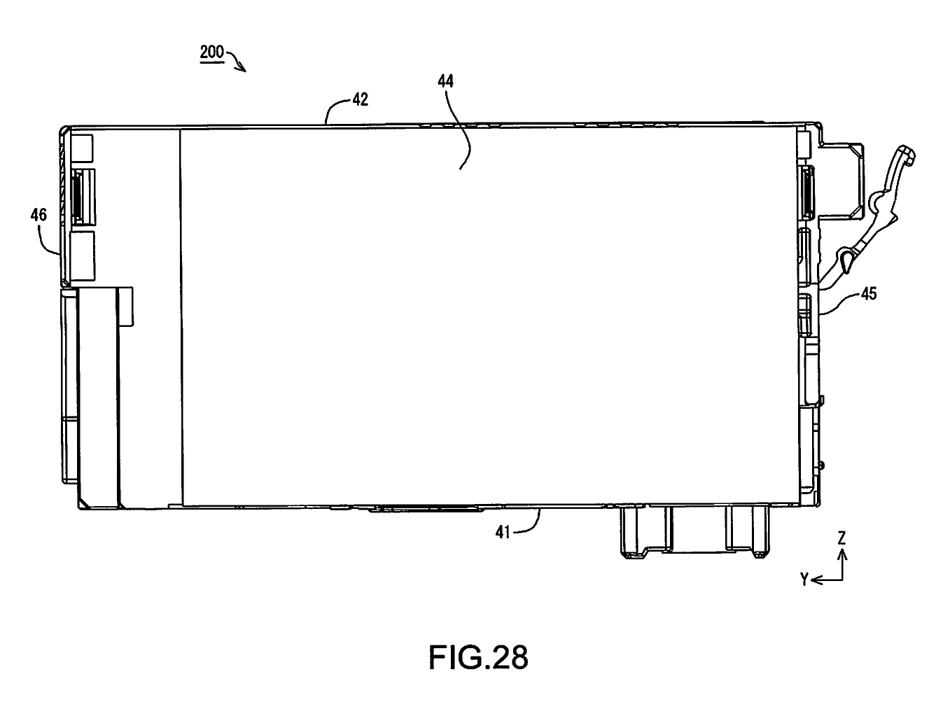

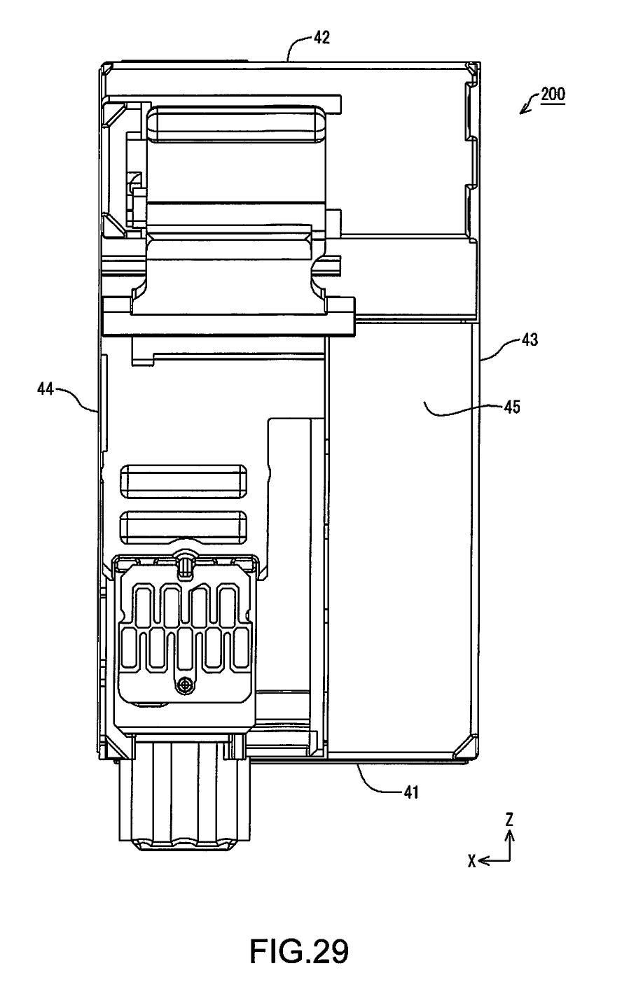

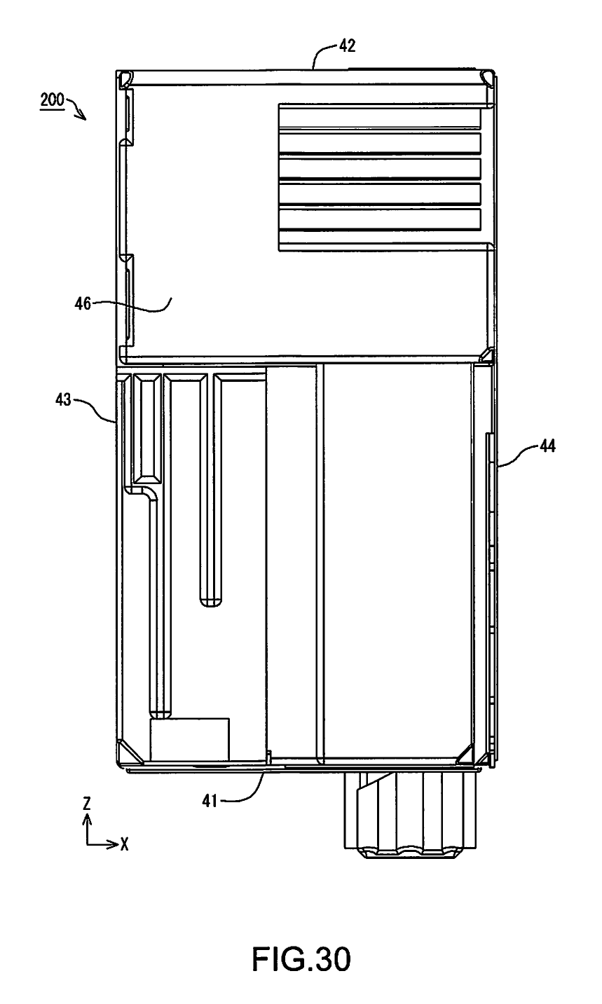

The cartridge 200 also has the fourth wall portion 44 as shown in FIG. 28. FIG. 28 illustrates a state where the cartridge 200 is seen in a planar view in the −X axis direction. The cartridge 200 also has the fifth wall portion 45 as shown in FIG. 29. FIG. 29 illustrates a state where the cartridge 200 is seen in a planar view in the Y axis direction. The cartridge 200 also has the sixth wall portion 46 as shown in FIG. 30. FIG. 30 illustrates a state where the cartridge 200 is seen in a planar view in the −Y axis direction. Note that similarly to the first embodiment and the second embodiment, the first to sixth wall portions 41 to 46 are not limited to a flat wall, and may include recessions and protrusions, or may include a curved surface.

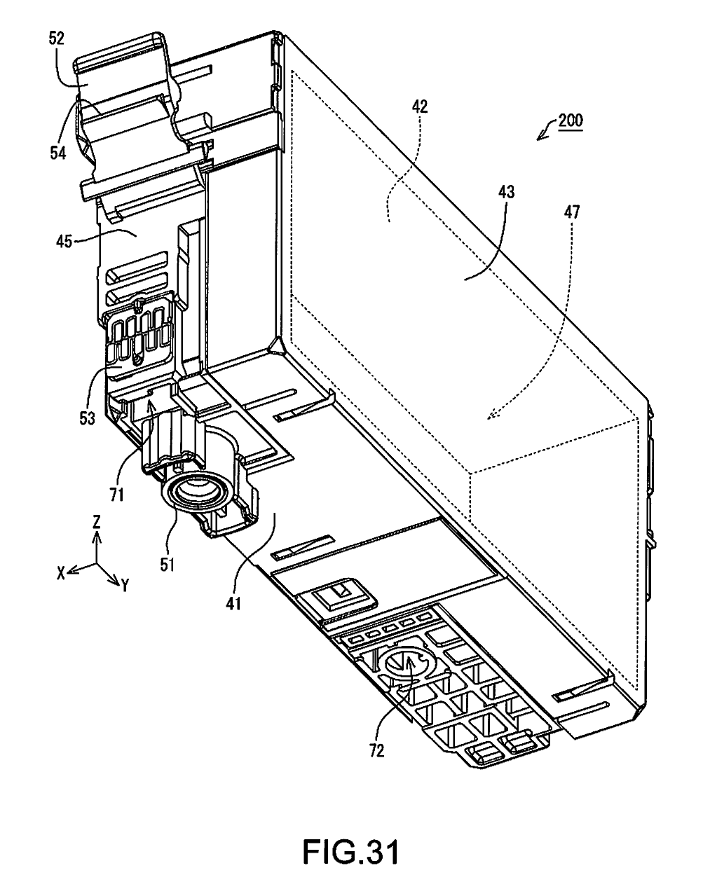

As shown in FIG. 25, the distance between the third wall portion 43 and the fourth wall portion 44 of the cartridge 200, in other words, the width dimension along the X axis of the cartridge 200 is different from that of the cartridge 7 and the cartridge 102. Except for this, the cartridge 200 has a configuration similar to that of the cartridge 7 and the cartridge 102. In the cartridge 200, the width dimension along the X axis of the cartridge 200 is greater than that of the cartridge 7 and the cartridge 102. Accordingly, as shown in FIG. 31, the volume of the liquid container 47 is greater than the volume of the liquid container 47 of the cartridge 7 and the cartridge 102. According to such a configuration, the volume of ink that can be contained in the cartridge 200 is greater than that of the cartridge 7 and the cartridge 102. Accordingly, it is possible to reduce the frequency of replacing the cartridge 200 in the liquid ejecting system 1 and the liquid ejecting system 100.

Also in the cartridge 200, similarly to the first embodiment and the second embodiment, in a planar view of the first wall portion 41 in the first direction from the first wall portion 41 toward the second wall portion 42, in other words, in a planar view of the first wall portion 41 in the Z axis direction, the liquid supplying portion 51 is positioned closer to the fifth wall portion 45 than to the sixth wall portion 46 as shown in FIG. 25. Also, the first recess portion 71 is positioned closer to the fifth wall portion 45 than the liquid supplying portion 51, and the second recess portion 72 is positioned closer to the sixth wall portion 46 than the liquid supplying portion 51. In addition, when equally dividing the first wall portion 41 into the first region 81, the second region 82 and the third region 83 in a direction from the fifth wall portion 45 toward the sixth wall portion 46, in other words, in the Y axis direction, the first recess portion 71 is positioned in the first region 81, and the second recess portion 72 is positioned in the third region 83. Note that in the cartridge 200, the lever 52, the circuit substrate 53, the first recess portion 71, the liquid supplying portion 51, and the second recess portion 72 are positioned closer to the fourth wall portion 44 than to the third wall portion 43 in the X axis direction. Furthermore, in a configuration in which the detection target unit 92 is provided, the detection target unit 92 is also positioned closer to the fourth wall portion 44 than to the third wall portion 43 in the X axis direction.

Also in the third embodiment, effects similar to those of the first embodiment and the second embodiment are obtained.

### Modified Example 1

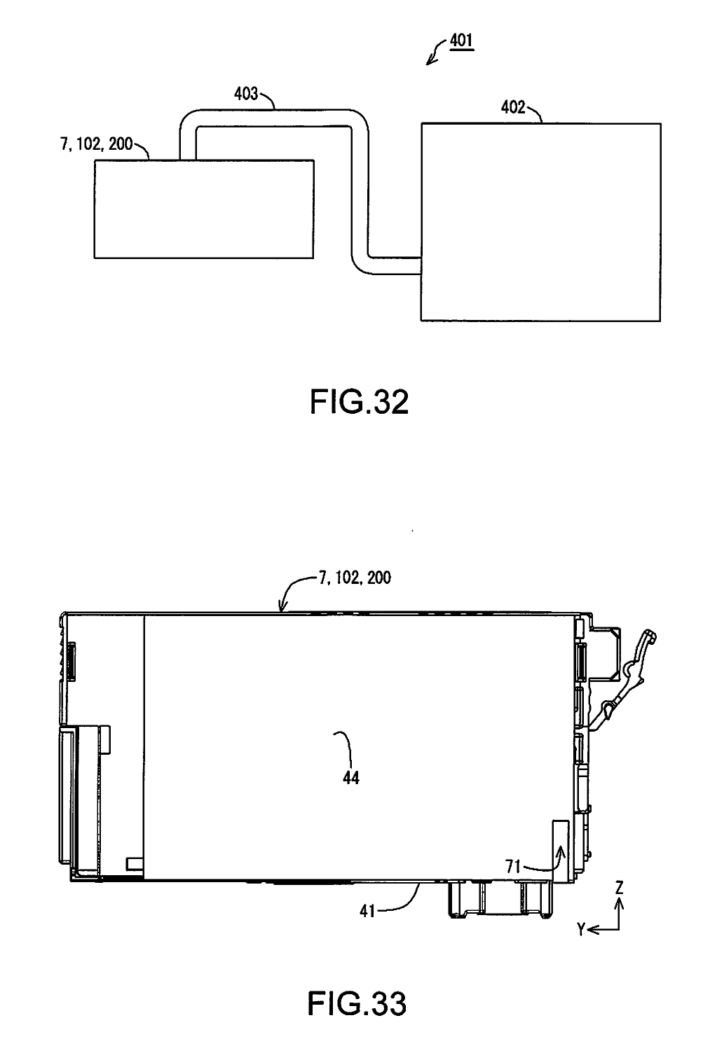

A liquid supplying unit for supplying a liquid to a liquid ejecting apparatus is not limited to the cartridge 7, the cartridge 102 and the cartridge 200, which are examples of the liquid supplying unit. Another example of the liquid supplying unit will be described as Modified Example 1. A liquid supplying unit 401 of Modified Example 1 has, as shown in FIG. 32, the above-described the cartridge 7, the cartridge 102 or the cartridge 200, a tank 402 and an ink supplying tube 403. The tank 402 contains ink to be supplied to the above-described the cartridge 7 or the cartridge 102. The ink supplying tube 403 guides the liquid from the tank 402 to the cartridge 7, the cartridge 102, or the cartridge 200. The ink supplying tube 403 has flexibility.

Moreover, in the liquid supplying unit 401 of Modified Example 1, the cartridge 7, the cartridge 102 or the cartridge 200 is mounted to the carriage 9 (FIGS. 1 and 21), while the tank 402 is provided independently from the carriage 9. In other words, in Modified Example 1, the tank 402 is not mounted to the carriage 9. Therefore, it is possible to increase the amount of ink that can be supplied to the liquid ejecting apparatus while reducing the load on the carriage 9. Furthermore, if a configuration is adopted in which the tank 402 can be refilled with new ink, it is possible to reduce or eliminate a suspension period of the liquid ejecting apparatus due to ink shortage.

### Modified Example 2

In the above-described cartridge 7, the cartridge 102 and the cartridge 200, the first recess portion 71 is open in the first wall portion 41. In other words, in the above-described cartridge 7, the cartridge 102 and the cartridge 200, the first recess portion 71 is open in the −Z axis direction. However, the direction in which the first recess portion 71 is open is not limited thereto. For example, as shown in FIG. 33, a configuration can also be adopted in which the first recess portion 71 is also open in the fourth wall portion 44. In this case, the first recess portion 71 is open in a direction from the second wall portion 42 toward the first wall portion 41 (the −Z axis direction) and in a direction from the third wall portion 43 toward the fourth wall portion 44 (the X axis direction). In other words, with this configuration, the first recess portion 71 is open in the first wall portion 41 and the fourth wall portion 44. According to such a configuration, the first recess portion 71 is open in two directions, and thus it is possible to make it easy to insert the first projection 31 into the first recess portion 71. This can make it easy to mount the cartridge 7, the cartridge 102 or the cartridge 200 to the carriage 9. Note that the configuration of the first recess portion 71 is not limited to the configuration of being open in the first wall portion 41 and the fourth wall portion 44. As the configuration of the first recess portion 71, a configuration can also be adopted in which the first recess portion 71 is open in the first wall portion 41 and the third wall portion 43. With this configuration as well, a similar effect can be obtained.

### Modified Example 3

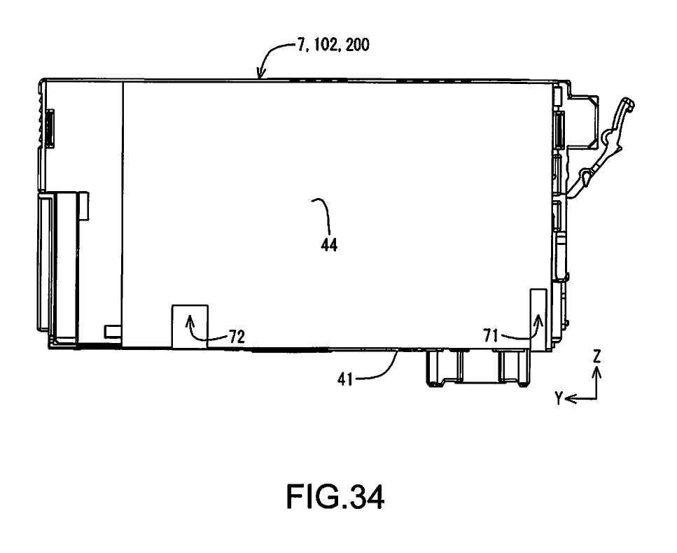

Also, in the above-described cartridge 7, cartridge 102 and cartridge 200, the second recess portion 72 is open in the first wall portion 41. In other words, in the above-described cartridge 7, the cartridge 102 and the cartridge 200, the second recess portion 72 is open in the −Z axis direction. However, the direction in which the second recess portion 72 is open is not limited thereto. For example, a configuration can also be adopted in which the second recess portion 72 is also open in the fourth wall portion 44 as shown in FIG. 34. In this case, the second recess portion 72 is open in a direction from the second wall portion 42 toward the first wall portion 41 (the −Z axis direction) and in a direction from the third wall portion 43 toward the fourth wall portion 44 (the X axis direction). In other words, with this configuration, the second recess portion 72 is open in the first wall portion 41 and the fourth wall portion 44. According to such a configuration, the second recess portion 72 is open in two directions, and thus it is possible to make it easy to insert the second projection 32 into the second recess portion 72. This can make it easy to mount the cartridge 7, the cartridge 102 or the cartridge 200 to the carriage 9. Note that the configuration of the second recess portion 72 is not limited to a configuration of being open in the first wall portion 41 and the fourth wall portion 44. As the configuration of the second recess portion 72, a configuration can also be adopted in which the second recess portion 72 is open in the first wall portion 41 and the third wall portion 43. With this configuration as well, a similar effect can be obtained.

The invention is not limited to an inkjet printer and an ink cartridge thereof, and can also be applied to any printing apparatus that ejects a liquid other than ink and a cartridge used for such a printing apparatus. For example, the invention can be applied to various printing apparatuses as follows and cartridges thereof:

(1) an image recording apparatus such as a facsimile apparatus, (2) a printing apparatus that ejects color material used for manufacturing color filters for an image display device such as a liquid crystal display, (3) a printing apparatus that ejects electrode materials used for forming electrodes for an organic EL (Electro Luminescence) display, an FED (Field Emission Display) and the like, (4) a printing apparatus that ejects a liquid containing biological organic matter used for manufacturing biochips, (5) a sample printing apparatus serving as a precision pipette, (6) a printing apparatus for a lubricant, (7) a printing apparatus for a resin liquid, (8) a printing apparatus that ejects a lubricant onto precision instruments such as time pieces and cameras with pinpoint accuracy, (9) a printing apparatus that ejects a transparent resin liquid such as an ultraviolet-curing resin liquid onto a substrate in order to form, for example, a hemispherical micro lens (optical lens) used in an optical communication element or the like, (10) a printing apparatus that ejects an acid or alkali etching solution in order to etch a substrate or the like, and (11) a printing apparatus provided with a liquid ejecting head for discharging a minute amount of any other liquid droplets.

Note that “liquid droplets” refer to a state of a liquid that is discharged from a printing apparatus, and includes a liquid that leaves a trail in the form of particles, tears, or threads. It suffices for the “liquid” to be a material that can be ejected by the printing apparatus. For example, it suffices for the “liquid” to be a material in a state where the substance is in the liquid phase, and the “liquid” includes materials in a liquid state such as high- or low-viscosity liquids, and materials in a liquid state such as sols, gel waters, other inorganic solvents, organic solvents, solutions, liquid resins, and liquid metals (molten metals). The “liquid” includes not only liquids in the form of one state of a substance, but also solvents into which particles of a functional material composed of a solid matter such as a pigment or metal particles has been dissolved, dispersed or mixed, and the like. The “liquid” as described above can also be expressed as “liquid body”. Representative examples of liquids and liquid bodies include ink, such as was described in the above embodiments, liquid crystal and the like. Herein, the term “ink” encompasses a variety of compositions in the form of a liquid, such as general water-soluble inks and oil-soluble inks as well as gel inks, and hot melt inks.

Note that the invention is not limited to the above embodiments and examples, and can be achieved as various configurations without departing from the gist of the invention. For example, the technical features in the embodiments and examples that correspond to the technical features in the aspects described in the summary of the invention may be replaced or combined as appropriate in order to solve a part of, or the entire foregoing problem, or to achieve some or all of the above-described effects. The technical features that are not described as essential in the specification may be deleted as appropriate.

What is claimed is:

1. A liquid supplying unit that is mountable to a carriage having a first projection, a second projection and a liquid introduction needle positioned between the first projection and the second projection, the liquid supplying unit comprising:
a first wall portion;
a second wall portion opposing the first wall portion;
a third wall portion intersecting the first wall portion and the second wall portion;
a fourth wall portion intersecting the first wall portion and the second wall portion, and opposing the third wall portion;
a fifth wall portion intersecting the first wall portion, the second wall portion, the third wall portion and the fourth wall portion; and
a sixth wall portion intersecting the first wall portion, the second wall portion, the third wall portion and the fourth wall portion, and opposing the fifth wall portion, wherein
the first wall portion is provided with a liquid supplying portion adapted to connect to the liquid introduction needle, a first recess portion adapted to receive the first projection, and a second recess portion adapted to receive the second projection, and
in a planar view of the first wall portion in a direction from the first wall portion toward the second wall portion:
the liquid supplying portion is positioned closer to the fifth wall portion than to the sixth wall portion; and
when the first wall portion is equally divided into a first region, a second region and a third region in a direction from the fifth wall portion toward the sixth wall portion, the first recess portion is positioned in the first region, and the second recess portion is positioned in the third region.

2. The liquid supplying unit according to claim 1, wherein
the first wall portion is provided with a detection target unit in which a liquid residual quantity is detected, and
in a planar view of the first wall portion in the direction from the first wall portion toward the second wall portion:
the liquid supplying portion is positioned closer to the fifth wall portion than to the sixth wall portion;
the first recess portion is positioned closer to the fifth wall portion than the liquid supplying portion;
the second recess portion is positioned closer to the sixth wall portion than the liquid supplying portion; and
the detection target unit is positioned between the first recess portion and the second recess portion in a direction from the fifth wall portion toward the sixth wall portion.

3. The liquid supplying unit according to claim 1, further comprising:
a contact portion that is arranged on the fifth wall portion, and that comes into contact with an electrode of the carriage in a state where the liquid supplying unit is mounted to the carriage, wherein
in a planar view of the first wall portion in the direction from the first wall portion toward the second wall portion,
a portion of the liquid supplying portion capable of abutting on the liquid introduction needle, the contact portion, the first recess portion and the second recess portion are arranged along a straight line.

4. The liquid supplying unit according to claim 1, wherein
the fifth wall portion is provided with an engagement structure configured to engage with the carriage in a state where the liquid supplying unit is mounted to the carriage, so as to regulate displacement of the liquid supplying unit relative to the carriage in a first direction from the first wall portion toward the second wall portion, and
in a planar view of the first wall portion in the direction from the first wall portion toward the second wall portion:
a portion of the engagement structure capable of abutting on the carriage, the portion of the liquid supplying portion capable of abutting on the liquid introduction needle, the first recess portion and the second recess portion are arranged on a straight line.

5. The liquid supplying unit according to claim 1, wherein
the first recess portion is open in a direction from the second wall portion toward the first wall portion and in a direction from the third wall portion toward the fourth wall portion.

6. The liquid supplying unit according to claim 1, wherein
the second recess portion is open in a direction from the second wall portion toward the first wall portion and in a direction from the third wall portion toward the fourth wall portion.

7. A liquid ejecting system comprising a carriage and a liquid supplying unit that is mounted to the carriage and that is capable of containing a liquid, wherein
the carriage comprises:
a first projection;
a second projection; and
a liquid introduction needle positioned between the first projection and the second projection,
the liquid supplying unit comprises:
a first wall portion;
a second wall portion opposing the first wall portion;
a third wall portion intersecting the first wall portion and the second wall portion;
a fourth wall portion intersecting the first wall portion and the second wall portion, and opposing the third wall portion;
a fifth wall portion intersecting the first wall portion, the second wall portion, the third wall portion and the fourth wall portion; and
a sixth wall portion intersecting the first wall portion, the second wall portion, the third wall portion and the fourth wall portion, and opposing the fifth wall portion,
the first wall portion is provided with a liquid supplying portion connectable to the liquid introduction needle, a first recess portion adapted to receive the first projection, and a second recess portion adapted to receive the second projection,
in a planar view of the first wall portion in a first direction from the first wall portion toward the second wall portion:
the liquid supplying portion is positioned between the fifth wall portion and the sixth wall portion; the first recess portion is positioned between the fifth wall portion and the liquid supplying portion; and the second recess portion is positioned between the sixth wall portion and the liquid supplying portion,
assuming a direction from the second wall portion toward the first wall portion to be a second direction, the liquid supplying portion protrudes from the first wall portion in the second direction,
the liquid supplying portion protrudes farther than a portion of the first wall portion in which the first recess portion is provided, by a first distance in the second direction,
the first projection protrudes farther than the liquid introduction needle by a second distance in the first direction, and
the second distance is greater than the first distance.

8. The liquid ejecting system according to claim 7, wherein
the second projection protrudes farther than the liquid introduction needle by a third distance in the first direction, and
the third distance is greater than the first distance.

9. The liquid ejecting system according to claim 8, wherein
the liquid supplying unit further comprises a contact portion that is arranged on the fifth wall portion, and that comes into contact with an electrode of the carriage, and
the second distance is greater than the third distance.

10. The liquid ejecting system according to claim 9, wherein
the first recess portion and the contact portion are provided at positions opposing each other such that the fifth wall portion is positioned therebetween.

11. The liquid ejecting system according to claim 7, comprising:
a detecting unit configured to detect a residual quantity of the liquid contained in the liquid supplying unit, wherein
the liquid supplying unit has, in the first wall portion, a detection target unit in which the residual quantity of the liquid is detected by the detecting unit, and
in a planar view of the first wall portion in a direction from the first wall portion toward the second wall portion:
the liquid supplying portion is positioned closer to the fifth wall portion than to the sixth wall portion;
the first recess portion is positioned closer to the fifth wall portion than the liquid supplying portion;
the second recess portion is positioned closer to the sixth wall portion than the liquid supplying portion; and
the detection target unit is positioned between the first recess portion and the second recess portion in a direction from the fifth wall portion toward the sixth wall portion.
